(19) United States
(12) Patent Application Publication
(10) Pub. No.: US 2026/0044740 A1
(43) Pub. Date: Feb. 12, 2026

(54) INCREMENTAL TRAINING FOR DYNAMIC AND SCALABLE ADAPTERS

(71) Applicant: BMC Software, Inc., Houston, TX (US)

(72) Inventors: Sai Eswar Garapati, San Jose, CA (US); Erhan Giral, Danville, CA (US); Christopher Joel Holdbrooks, Friant, CA (US)

(21) Appl. No.: 18/796,155

(22) Filed: Aug. 6, 2024

(51) Int. Cl. G06N 3/096; G06N 3/045

(52) U.S. Cl. CPC G06N 3/096; G06N 3/045

(57) ABSTRACT

In described systems and techniques, network data may be analyzed using a combination of a primary model and a secondary model to obtain first network analysis results. A training instance of the secondary model may be trained using the network data and the first network analysis results. The secondary model may be updated using the training instance to obtain an updated secondary model. Additional network data may then be processed using a combination of the primary model and the updated secondary model.

### TECHNICAL FIELD

This description relates to network event management.

### BACKGROUND

Many companies and other entities have extensive technology landscapes that include numerous Information Technology (IT) assets, including hardware and software. It is often required for such assets to perform at high levels of speed and reliability, while still operating in an efficient manner. For example, various types of computer systems are used by many entities to execute business-critical applications and high volumes of data processing, across many different workstations and peripherals.

Various types of system monitoring methods are used to detect, predict, prevent, mitigate, or cure system faults that might otherwise disrupt or prevent monitored IT assets from achieving system goals. For example, it is possible to monitor various types of performance metrics characterizing aspects of system performance. When monitored values of the detected performance metrics exceed a predetermined threshold, the monitored values may be considered potentially indicative of a current or future system malfunction, and responsive action may be taken.

In other examples, log records may be captured over time to be able to identify, track, diagnose, and repair malfunctions, or to optimize the efficiency or reliability of underlying components or systems. In still other examples, manual and/or automated help desks may be maintained to provide assistance to users who experience difficulties within a given technology landscape.

Trained machine learning (ML) models may be used to support the above and other aspects of maintaining resources within a technology landscape. In many cases, however, it may be difficult, time-consuming, or expensive to train such ML models. Moreover, even if training is implemented successfully in a specific context, it may be difficult to reproduce such training over time and/or for other contexts, particularly when the ML models are intended to be deployed within many such contexts.

### SUMMARY

According to one general aspect, a computer program product may be tangibly embodied on a non-transitory computer-readable storage medium and may comprise instructions. The instructions, when executed by at least one computing device, may be configured to cause the at least one computing device to analyze network data using a combination of a primary model and a secondary model to obtain first network analysis results, and then train a training instance of the secondary model using the network data and the first network analysis results. The instructions, when executed by the at least one computing device, may be configured to cause the at least one computing device to update the secondary model using the training instance to obtain an updated secondary model, and process additional network data using a combination of the primary model and the updated secondary model.

According to other general aspects, computer-implemented methods may perform the instructions of the computer program products. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program products and/or the operations of the computer-implemented methods.

The details of one or more implementations are set forth in the accompanying drawings and the description below. Other features will be apparent from the description and drawings, and from the claims.

### BRIEF DESCRIPTION OF THE DRAWINGS

FIG. 1A is a block diagram of a system for incremental training for dynamic and scalable adapters.

FIG. 1B is a block diagram illustrating an example implementation of the system of FIG. 1A.

FIG. 2A is a flowchart illustrating example operations for incremental training in the systems of FIGS. 1A and 1B.

FIG. 2B is a flowchart illustrating example operations for dynamic and scalable adapters in the systems of FIGS. 1A and 1B

FIG. 3 is a block diagram illustrating a more detailed example of incremental training that may be used in the systems of FIGS. 1A and 1B.

FIG. 4 is a block diagram illustrating example weight adjustments that may be made in the example of FIG. 3.

FIG. 5 is a flowchart illustrating example operations for the weight adjustments of FIG. 4.

FIG. 6 is a block diagram of an example implementation of the system of FIG. 1B.

FIG. 7 is a block diagram of an example transformer layer that may be used to implement the system of FIG. 1A.

FIG. 8 is an example of a more detailed view of the example transformer layer of FIG. 7.

FIG. 9 is a more detailed example of a low rank adapter of FIG. 8.

FIG. 10 is a block diagram of an example multi-head attention layer of the example transformer layer of FIG. 7.

FIG. 11 is a first example operation of the multi-head attention layer of FIG. 10.

FIG. 12 is a second example operation of the multi-head attention layer of FIG. 10, using key-value caching.

FIG. 13 is a third example operation of the multi-head attention layer of FIG. 10, using key-value caching.

FIG. 14 is a fourth example operation of the multi-head attention layer of FIG. 10, using key-value caching.

FIG. 15 is a block diagram of an example shared paging memory pool that can be used in the example system of FIG. 6, including use of the key-value caching approach of FIGS. 11-14.

### DETAILED DESCRIPTION

Sustaining the stability and reliability of large-scale networks has been an important need in the IT management area. It is challenging, however, to provide such stability and reliability in a practical IT environment(s), due to the dynamic, evergrowing, and distributed nature of large-scale enterprise networks. Effective management of such environments typically requires an in-depth understanding of multiple domains within a business to communicate and resolve the problem(s). Moreover, such environments may also vary from one business to another.

For example, within a single business, e.g., a single company, multiple domains within an IT environment of the business may include, without limitation, network operations (e.g., anomaly detection), human resources data management, incident/ticket management, Internet of Things (IoT) monitoring, or network log management, among others. Within a single business, many differences will exist between these domains in terms of, e.g., terminologies, typical problems/solutions, and required resources. Among multiple businesses, each business may have the same or overlapping domains, yet may have many additional differences between corresponding domains (e.g., between human resources domains of two different businesses), due to the natures of the businesses involved.

A provider of network management software and related services may seek to provide support across all such domains for many different types of businesses. For example, such a provider may provide trained large language models (LLMs) and other machine learning (ML) techniques to process various types of inputs and provide corresponding outputs.

Such inputs (and corresponding outputs) may vary based on corresponding differences in the types of domains referenced above, as well as on the types of differences among separate businesses that are also referenced above. For example, in the context of incident/ticket management (e.g., help desk environments), inputs may include textual descriptions of problems experienced by users, while outputs may include descriptions of solutions provided in response. In the context of log management, inputs may include time-stamped log records having a well-defined format, while outputs may include analysis results of a set of log records that identify, e.g., a source of a problem or an area for optimization. In the context of network management, inputs may include directed graphs in which network components are provided as nodes connected by known or determined relationships, while outputs may include knowledge determined from such graphs, such as a source node of a detected anomaly.

As referenced above, LLMs and other machine learning techniques may be used to provide, automate, or facilitate many useful aspects of IT network management. For example, a LLM may input an incident ticket with lengthy textual portions describing the problem that the user is experiencing with his or her computer system, a history of a corresponding problem that was already resolved and output a summary of the relevant portions of the problem and resolution. In other examples, a LLM may input a description of a network anomaly and output a potential solution for resolving the anomaly.

LLMs, however, typically require very large quantities of computing resources, can be difficult to train and deploy, and are therefore expensive to implement. For example, a LLM may utilize billions of weights and other parameters, and may require specialized processors (e.g., graphical processor units, or GPUs) and associated specialized memories (e.g., GPU memories).

It is possible to pre-train such models for general language processing, and then fine-tune the pre-trained models for more specific environments, such as IT management. However, such approaches are still impractical for deploying LLMs among the many different domains referenced above, much less among the different versions of such domains that exist between different businesses. Moreover, it is not practical to repeat the training and/or fine-tuning process(es) frequently enough to keep up with changes within the underlying IT environments. As a result, attempts to use conventional approaches to training and deploying LLMs and other ML models in the context of IT management result in LLMs that provide, at best, overly generic outputs and/or solutions that are prone to becoming obsolete.

Described techniques, in contrast, use the above-referenced types of LLMs as a foundation or primary model(s), while using multiple smaller models, referred to herein as expert models, to facilitate specialized and highly customized processing of IT data. For example, such expert models may be incrementally trained over time, using training techniques that are fast and accurate, but that are infeasible for use in training the larger, underlying model. Then, multiple ones of such expert models may be deployed, so that an appropriate one of such expert models may be selected and deployed in combination with the underlying primary model to process a corresponding type of IT data.

For example, a primary LLM or other model may be trained, using conventional techniques, to process all sorts of IT data. Then, a first expert model may be trained for use in the example context of incident tickets and/or help desk contexts, while a second expert model may be trained for use in the example context of log record management. Incoming requests may be routed for processing by either the first expert model or the second expert model, and either expert model may be implemented in the context of the primary model, depending on which request is current being processed.

Over time, as new data is processed by each of the expert models, the training of each expert model may become out of date or obsolete. For example, new problems/solutions may occur in the help desk context, or new types of log records may be defined in the log record context.

Using described techniques, each of the expert models may be incrementally trained using most-recently processed data (most-recent data) as training data. Such incremental training may be provided without any fine-tuning or other retraining of the primary model. Moreover, such incremental training may be executed by making direct, relative adjustments of weights of the expert model(s), rather than by using fine-tuning or other traditional training techniques.

For example, most-recent data may be used to train a corresponding training instance of an expert model, thereby yielding training weights of the training instance. For example, data from a preceding month may be used to train a training instance of the expert model.

Then, weights of the corresponding expert model (which may have been trained on a larger set of training data, e.g., training data from a preceding year) may be adjusted (e.g., increased or decreased) by determined amounts, based on relevant subsets of the training weights of the training instance. In other words, in the example, most-relevant weights of the preceding month may be identified and then merged with (e.g., used to adjust) corresponding weights of the corresponding expert model.

Such an approach is advantageous, for example, because the training instance of the expert model may be trained quickly and inexpensively, because it corresponds only to a small subset of most-recent data. The training instance may then be used to identify most-relevant weights, which may then be used to adjust corresponding weights of the corresponding expert model (without requiring retraining of the expert model), where the expert model is itself very small in size when compared to the underlying primary model.

Thus, considerable time and computing resources may be saved through the use of described incremental training approaches. Additionally, described incremental training approaches provide IT data processing that is highly customized and that is consistently up to date with respect to reflecting changes, situations, solutions, or other aspects of IT data that may evolve over time.

During deployment, the various expert models may be hot swapped with one another within the primary model as needed to respond to corresponding requests. For example, in the examples above, the help desk expert model may be used in conjunction with the primary model to process help desk data, while the log record expert model may be used in conjunction with the primary model to process log record data.

In example techniques, shared memory may be used, e.g., to provide caching techniques that facilitate fast and efficient data processing. Such caching techniques may be impractical for use in the context of traditional LLMs, but are extremely advantageous in the context of the smaller expert models described herein. Moreover, the shared memory may be shared among multiple expert models, so that the caching techniques may be leveraged across the multiple expert models, as well.

In some implementations, currently active expert models may be maintained within relatively expensive GPU memory while being used, while inactive expert models may be stored using relatively less expensive memory (e.g., main memory or central processing unit (CPU) memory). For example, an inactive expert model(s) (e.g., the help desk expert model) may be stored in CPU memory until a request is received that is intended for the inactive expert model, at which time the expert model may be copied into the GPU memory for handling of the request. More generally, for example, a pool of most-recently used expert models may be maintained in a GPU memory, with individual ones (e.g., least-recently used ones) of these expert models being removed from the GPU memory as new expert models are loaded into the GPU memory from a CPU memory for current use thereof.

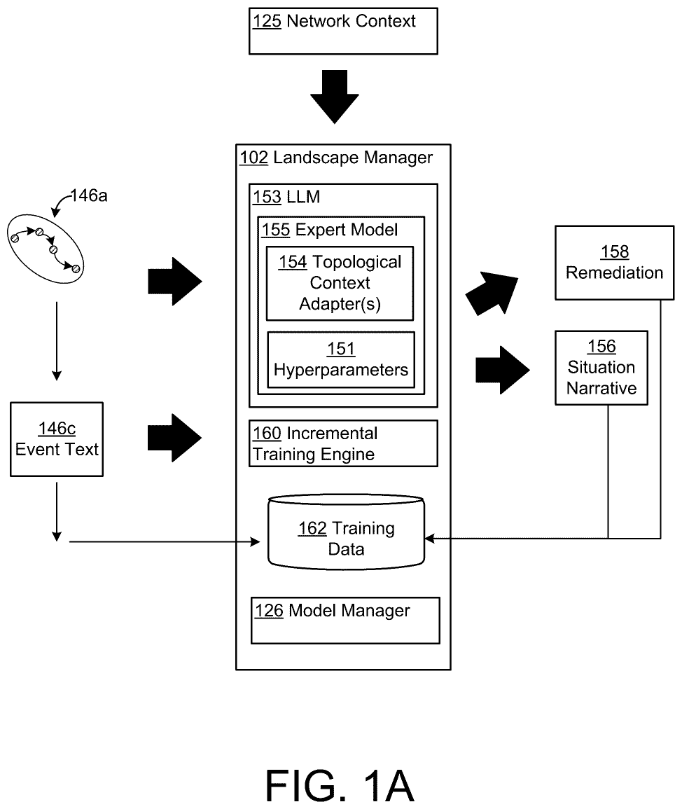

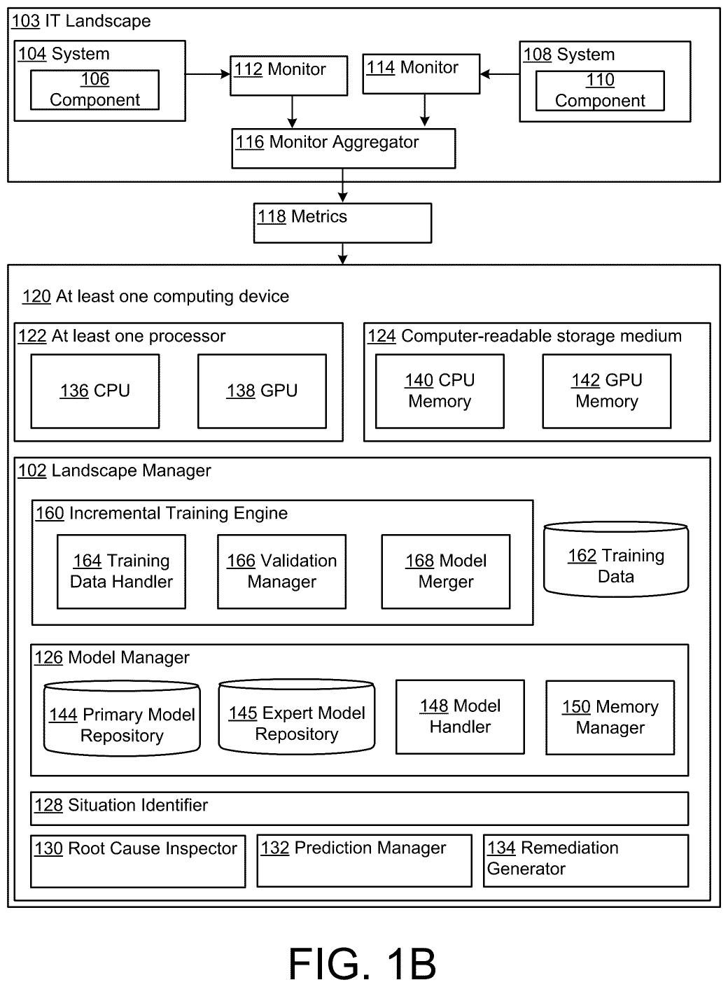

FIG. 1A illustrates a non-limiting example implementation in which the above-referenced techniques are used to process example event graph 146a (also referred to as an event cluster, or a situation), which is illustrated as a graph of multiple events. The event graph 146a may be associated with event text 146c, such as descriptive text. The event text 146c is illustrated separately in the simplified example of FIG. 1A, but should be understood to be included in, or determined with respect to, one or more individual events of the situation 146a.

It will be appreciated from the present description, however, that the event graph 146a and associated event text 146c represent only a single example of the many different types of IT data, or other types of data, that may be processed using described techniques. Additional and/or related examples include the log record processing or the incident ticket and/or help desk examples referenced above, and other examples are provided herein, as well.

In the example of FIG. 1A, a landscape manager 102 may be configured to input the event graph 146a and the event text 146c, perhaps with relevant network context 125, for processing by the type of large language model (LLM) 153 referenced above. For example, the network context 125 may include network topology data and/or knowledge graph data that may be relevant to the event graph 146a and associated event text 146c.

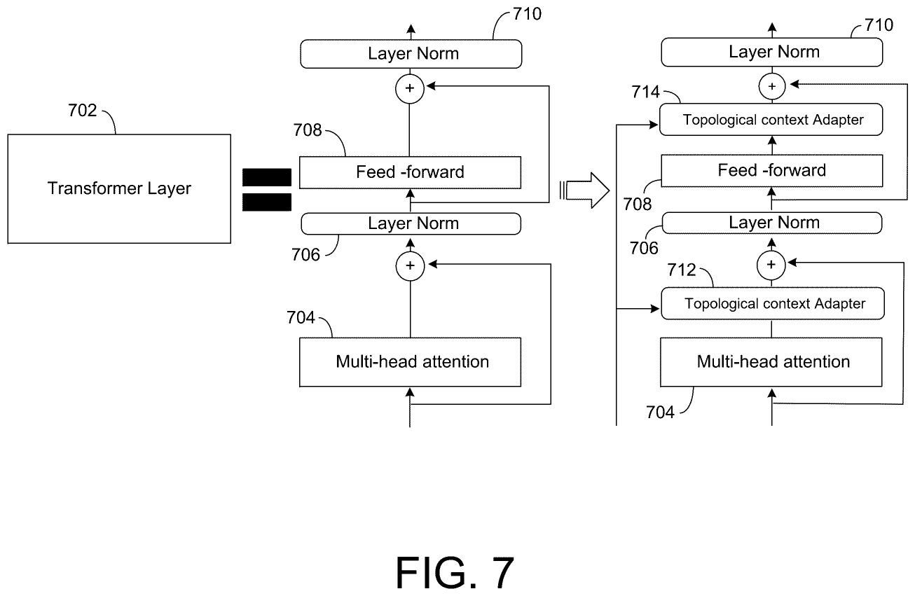

As further illustrated, the LLM 153 may include an expert model 155, which may include one or more topological context adapter(s) 154 and associated hyperparameter(s) 151, as referenced above and described in more detail, below. For example, detailed discussions of example structures of the LLM 153 and of the expert model 155, including the topological context adapter(s) 154 and associated hyperparameter(s) 151, are provided below, e.g., with respect to FIGS. 7-10.

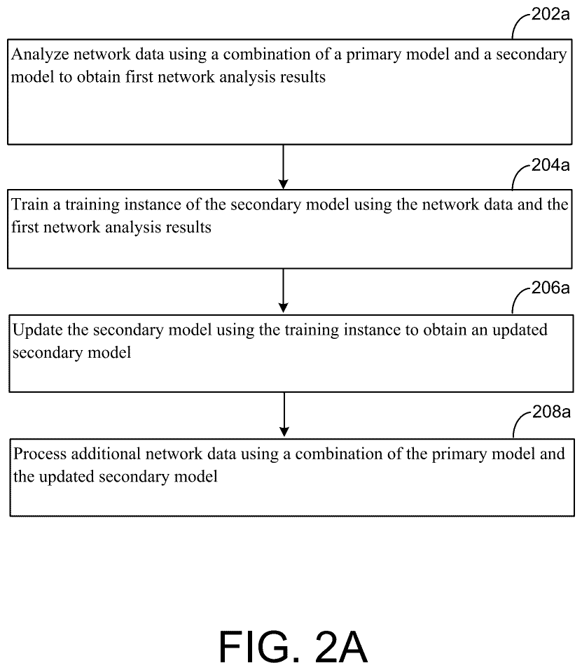

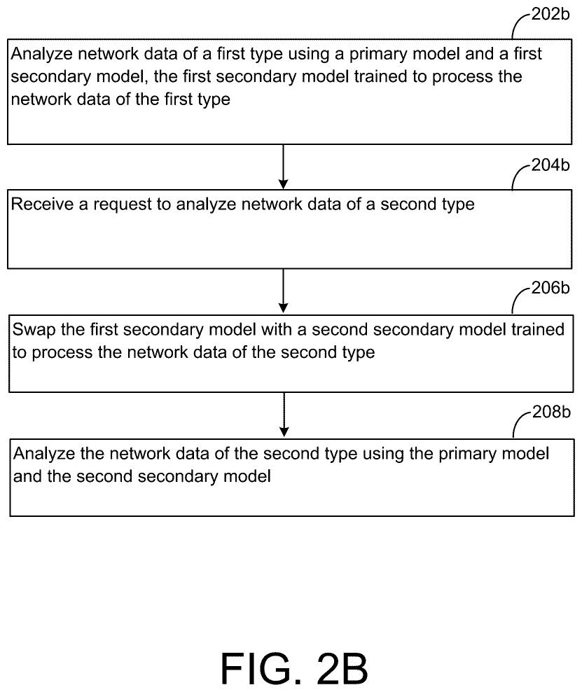

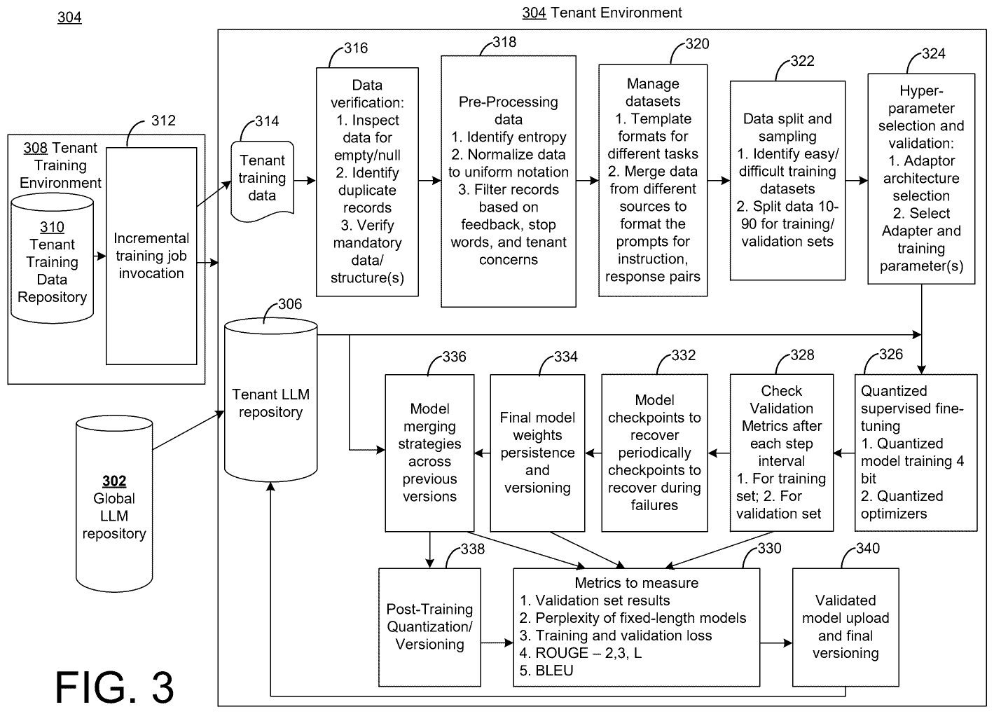

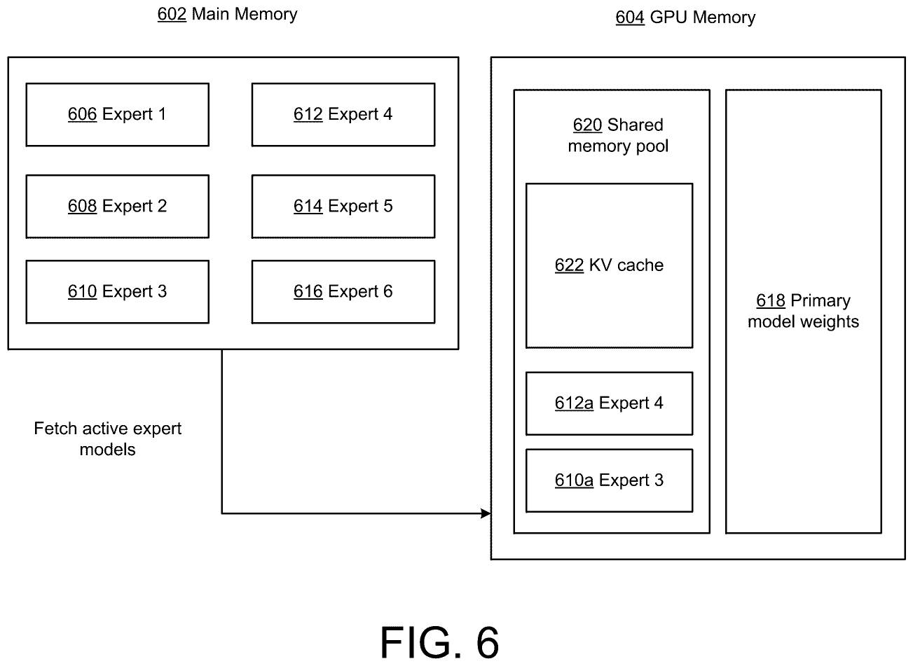

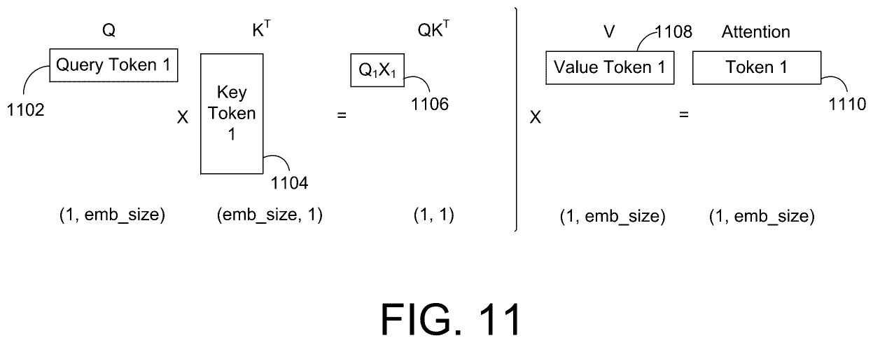

The simplified example of FIG. 1A illustrates only the single expert model 155 that is optimized for processing the event graph 146a and the event text 146c, but, as also described herein, other expert models may be combined with the LLM 153 to process other types of IT data for which those expert models are optimized. In other words, FIG. 1A illustrates the above-described examples in which the LLM 153 provides an example of a first or primary model, which may also be referred to as a foundation model, while the expert model 155 provides an example of a second or secondary model that is optimized for processing a particular type of data (e.g., the event graph 146a and/or the event text 146c), and which may be swapped for other expert models that are optimized for processing other, corresponding types of data. For example, a model manager 126 may be configured to manage such swapping of multiple expert models. More specific examples of such swapping and other management, use, and storage of multiple expert models, as may be provided by the model manager 126, are provided below, e.g., with respect to FIG. 1B, FIG. 2B, FIG. 3, FIG. 6, and FIGS. 11-15.

In FIG. 1A, the landscape manager 102 may thus be configured to process, e.g., the event graph 146a and/or associated event text 146c, along with the network context 125, to generate a corresponding situation narrative 156, which may include root cause identification and explanation for the event graph 146a. In other example implementations, the LLM 153 may be configured to process, e.g., the event graph 146a and/or associated event text 146c, along with the network context 125, to generate a corresponding remediation for a root cause of the processed event graph 146a.

Described techniques automatically generate the situation narrative 156 and/or the remediation 158 across different services, devices, and other IT components, within and among multiple domains that may span a varied topology, by adaptively training the LLM model 153, and incrementally training the expert model 155 over time as described herein, using topological and textual data.

For example, described techniques include capturing a textual and spatiotemporal context from situation causal event graphs. The LLM 153, which may be based on, e.g., a Generative Pretrained Transformer (GPT), may thus be trained to determine a relevant context, not just from a context of an individual event, but also from the context of surrounding events, as well as a topology context and temporal context of the situation. In this way, the customized LLM algorithm may be configured to generate a human-readable situation narrative 156 and/or remediation 158 that can be focused not only on the root cause and symptoms, but also on relevant topological characteristics of the IT system. Described custom LLMs may be utilized by various types of situation or incident detector(s) or handler(s) to generate accurate and comprehensive narratives, as well as helpful and actionable remediations, in a process(es) that may be adapted continuously to provide up-to-date solutions.

More specifically, for example, the expert model 155 may be incrementally trained using an incremental training engine 160 and associated training data 162 to enable the expert model 155 to provide a desired outcome, such as the situation narrative 156 or the remediation 158. For example, when training for generating the situation narrative 156, the training data 162 may include previously determined narratives associated with similar or related event graphs and associated situations, including root cause identification and explanation. When training for generating actionable remediations for resolving situations, the training data 162 may include previously determined remediations, worklogs, and other data associated with resolving previous IT situations.

As shown in FIG. 1A, when the expert model 155 is incrementally trained to generate the situation narrative 156, the resulting situation narrative 156 may be included in subsequent versions of the training data 162, perhaps after human review, modification, and training, for continuous adaptation and customization of the expert model 155. Similar comments apply when the expert model 155 is trained to generate the remediation 158, which may, in those scenarios, be fed back to the training data 162 to obtain up-to-date, accurate, and evolving remediations for future situations.

As referenced above, the term incremental training in the present description includes using the incremental training engine 160 to train a training instance of the expert model 155, using most-current data of the training data 162. Then, the incremental training engine 160 may compare a relevant, ranked subset of weights of the trained training instance to corresponding weights of the existing instance of the expert model 155. The incremental training engine 160 may then adjust relevant ones of the existing weights of the existing instance of the expert model 155 to obtain adjusted weights and thereby an adjusted and/or updated (e.g., incrementally trained) version of the expert model 155.

For example, the expert model 155 may have been trained using training data gathered at different times over the course of a calendar year. For example, in January, the training data 162 may be updated with data processed during that month, including, e.g., the processing of the event graph 146a and the event text 146c. In February, a training instance of the expert model 155 may be trained using the January training data.

Given that the amount of data gathered in January may be relatively small, the training instance may be trained quickly and easily, including obtaining up-to-date values of weights of the training instance of the expert model 155. Then, the training instance may be merged with the expert model 155 that existed prior to January. For example, a ranked subset of weights of the training instance (e.g., determined to be most relevant or most important for good quality outcomes within the context of the January data) may be merged with corresponding weights of the expert model 155 existing prior to January. For example, the weights of the existing expert model 155 may be adjusted (e.g., higher or lower) to an extent and in a manner that reflects a relative importance of the ranked subset of weights of the training instance. Similar processing may occur over ensuing months of February and March, including, e.g., accounting for trends in changes in values of the weights over that time frame. Additional example techniques for providing such incremental training are provided below, e.g., with respect to FIG. 1B and FIG. 2A, including specific example techniques for merging a training instance with an existing expert model by the types of weight identification and adjustment just described, e.g., with respect to FIGS. 3-5.

FIG. 1B is a block diagram illustrating an example implementation of the system of FIG. 1A. In the example of FIG. 1B, the IT landscape manager 102 of FIG. 1 may be configured to provide causal chain determination, root cause analysis, performance prediction, and remediation actions, as described in detail, below. More specifically, multiple expert models may be used, with each expert model 155 being optimized for at least one of the preceding purposes. Additionally, as with FIG. 1A, described purposes of the example expert models are non-limiting, and various other types of expert models may be used that are optimized for other contexts, some of which are referenced above and described below with respect to various ones of FIGS. 3-15.

For purposes of explaining example functionalities of the IT landscape manager 102, FIG. 1B illustrates an IT landscape 103 that includes a system 104 having a component 106, which represents a plurality of components of the system 104. Similarly, the IT landscape 103 includes a system 108 having a component 110, which may itself represent many different individual components. The systems 104, 108 may represent many different types of component-based systems, and the components 106, 110 may also represent many different types of components.

By way of non-limiting examples, the systems 104, 108 may represent various types of computing environments, such as a mainframe computing environment, a distributed server environment, or any computing environment of an enterprise or organization conducting network-based IT transactions. The systems 104, 108 may include many other types of network environments, such as a private network of an enterprise.

The systems 104, 108 may also represent scenarios in which the components 106, 110 represent various types of sensors, such as internet of things devices (IoT) used to monitor environmental conditions and report on corresponding status information. For example, the system 104 may be used to monitor patients in a healthcare setting, working conditions of manufacturing equipment, or other types of machinery in many industrial settings (including the oil, gas, or energy industry), or working conditions of banking equipment, such as automated transaction machines (ATMs).

Thus, the components 106, 110 should be understood broadly to represent any component that may be used in systems 104, 108 and other types of systems to perform a system-related function. Such components may include various types of hardware or software components, or combinations thereof. For example, the components 106, 110 may represent any infrastructure element(s). The components 106, 110 may represent a server, a workstation, a router, or a switch, or may represent more granular hardware components, such as an individual processor or a memory.

Similarly, the components 106, 110 may represent various types of software components, such as individual applications, or virtual machines. In further examples, a service may be a type of aggregated component that includes an orchestrated sequence or process of underlying hardware and software components. Many other components, including hosts, databases, or containers, may be included, some examples of which are provided below.

In some implementations, the system 104 and the system 108 may be geographically dispersed from one another. In other examples, the systems 104, 108 may be overlapping systems within a larger network, and may be co-located. Thus, the systems 104, 108 should be understood to represent virtually any IT landscape 103 that may be monitored and managed using the landscape manager 102.

In FIG. 1B, a monitor 112 is illustrated as monitoring the system 104, including the component 106, while the system 108 (and the component 110) may be monitored by a monitor 114. A monitor aggregator 116 may be configured to oversee and monitor the two or more monitors represented by the monitors 112, 114.

Accordingly, a plurality of metrics 118 may be obtained that provide data characterizing operations of the systems 104, 108, including, e.g., characterizations of a performance or other operations of the systems 104, 108, and of individual components 106, 110, thereof. The metrics 118 may be understood to be, for example, a sequence of metrics collected at defined time intervals or timesteps. For example, the metrics 118 may be collected every second, every minute, every 10 minutes, every 30 minutes, every hour, or at any other time period set by an administrator or other user.

Accordingly, the metrics 118 may represent any type of quantified performance characterizations that may be suitable for specific types of components. The metrics 118 represent and include performance metrics providing any corresponding type(s) of data that may be captured and reported, particularly in an ongoing, dynamic fashion, for any of the above-referenced types of systems and/or components, and various other systems, not specifically mentioned here for the sake of brevity. Metrics 118 may be defined with respect to technical device or network performance, and/or characterized with respect to relevant business performance.

For example, in a setting of online sales or other business transactions, the performance metrics 118 may characterize a condition of many servers being used. In a healthcare setting, the performance metrics 118 may characterize either a condition of patients being monitored or a condition of IoT sensors being used to perform monitoring of healthcare equipment. Similarly, the performance metrics 118 may characterize machines being monitored or IoT sensors performing such monitoring in manufacturing, industrial, telecommunications, energy, banking, or financial settings. In some examples, which may occur in mainframe, distributed server, or other networking environments, the performance metrics 118 may become or include key performance indicators also known as KPIs.

In the example of FIG. 1B, the system monitors 112, 114 are illustrated as separate components from the systems 104, 108. In various implementations, portions of the system monitors 112, 114 may be implemented within their respective systems, or within individual ones of the components 106, 110, and/or the components 106, 110 may be configured to output the metrics 118 directly.

In some implementations, monitoring may require specialized, proprietary, or otherwise configured interfaces to underlying systems or components. The monitor aggregator 116 may be configured to convert or format any monitored metrics, as needed, to provide the metrics 118 as a uniform stream of metrics for processing by the landscape manager 102.

In some implementations, the monitor aggregator 116 may be integrated with the landscape manager 102. In other implementations, e.g., if a smaller number or type of metrics is/are needed, then the landscape manager 102 may interface directly with the system monitors 112, 114 themselves, and the monitor aggregator 116 may be omitted.

As referenced above, the administrator or other user may wish to identify, classify, describe, or predict various network occurrences or other events. For example, such events may relate to, or describe different types of optimal or sub-optimal network behavior. For example, network characteristics such as processing speeds, available bandwidth, available memory, or transmission latencies may be evaluated. These and various other characteristics may be related to specific types of network events, such as a crash or a freeze, a memory that reaches capacity, or a resource that becomes inaccessible.

For ease of explanation, the below description is provided primarily with respect to the types of network-based examples just given. As may be appreciated from the above, however, such network examples are non-limiting, and the landscape manager 102 may be configured to provide similar functionalities in any of the other contexts referenced above (e.g., medical, IoT, manufacturing, or financial), and in many other contexts.

In many cases, the metrics 118 may represent extremely large quantities of data, since individual values for individual metrics may be collected at frequent time intervals. Consequently, it may be impractical or infeasible to store all such metric values. Moreover, there may be limited utility in storing metric values that are associated with normal system usage.

Therefore, the metrics 118 may be analyzed to determine whether any events are included therein, or may be determined therefrom, that may require processing by the landscape manager 102. In this context, the term event should be understood broadly to refer to any occurrence within the IT landscape 103 that may be determined from analysis of one or more metric value(s) of the metrics 118.

For example, a metric 118 may each be associated with a threshold value, and an event may be determined when the threshold value is exceeded (or not reached). For example, a memory being 80% full may cause a notification or alert to be generated, so that a response may be implemented to mitigate or avoid system failures. Such thresholds may be set in a static or dynamic fashion. Such thresholds may be set with respect to device or network performance requirement, and/or with respect to relevant business-performance requirements.

In other examples, the event may be determined from one or more metric values using other techniques. For example, a neural network may be trained to recognize a metric value as being anomalous in specific contexts. In other examples, the event may be determined for a particular metric value when the metric value varies to a certain extent, or in a predefined way, from historical norms for that metric value.

The event may be defined with respect to a single metric value, such as a particular memory, as just referenced, or may be defined with respect to multiple metric values. Multiple such single events may thus occur at a single timestep.

In other examples, an event may be defined with respect to a plurality or combination of variables, such as when a system crash affects multiple components. Therefore, an event may include one or more metric values and related information (e.g., generated alerts or thresholds exceeded), including specific combinations thereof.

In the example of FIG. 1B, the landscape manager 102 is illustrated as being provided using at least one computing device 120, which includes at least one processor 122 and a non-transitory computer-readable storage medium 124. Thus, the at least one computing device 120 may represent multiple computers, a mainframe(s), a server(s), a virtual machine(s), or other computing devices connected by a suitable network, any one of which may include multiple processors represented by the at least one processor 122, as well as multiple types of memories represented by the nontransitory computer-readable storage medium 124. For example, instructions, including instructions for implementing the landscape manager 102 or various components thereof, may be stored on the non-transitory computer-readable storage medium 124 for execution by the at least one processor 122.

The landscape manager 102 may be configured to provide multiple types of landscape management for the IT landscape 103. In FIG. 1B, by way of non-limiting example, the landscape manager 102 may use events identified from the metrics 118 as well as information from the network context 125 of FIG. 1A (e.g., topology data, knowledge graphs, and any other available sources of network data), to ensure smooth, continuous operation of the IT landscape 103 being monitored. For example, the landscape manager 102 may be configured to determine causal connections between event pairs to construct causal event clusters, which identify situations occurring within the IT landscape. Further, the landscape manager 102 may be configured to use the identified situations to determine root cause events thereof, to predict potential occurrences of similar situations in the future, and to automatically remediate actual or potential situations.

In more detail, the landscape manager 102 may include a situation identifier 128, which may be configured to analyze sets of events to determine one or more situations that have occurred, or are occurring, within the IT landscape 103. Such a situation(s) may refer to a group or cluster of individual events that are determined to be causally related to one another and that have some combined impact within the IT landscape 103.

For example, the situation may include a large-scale situation such as a system-wide crash. In other examples, the situation may include a smaller scale situation such as a component freeze. In general, the situation may be considered to include one or more events that require attention, repair, or remediation, or that have some other consequence for users of the IT landscape 103.

That is, some individual events may be transient or harmless when occurring in isolation. Some detected events may raise a false alarm and may not require any attention or action on the part of an administrator or user. Some detected events may have an impact that does not rise to the level of requiring action in response, such as when a response time of the component 110 is slowed, but a response time of the system 108 as a whole remains within acceptable levels.

The situation, on the other hand, as used herein, generally requires some response. The situation may reflect an aggregate impact of multiple events. In some cases, however, the situation could be caused by, or include a single event. In many cases, multiple situations may occur within a single time period, or across overlapping time periods. The situation identifier 128 may be configured to provide directed clusters of events that define corresponding situations, as described with respect to event graph 146a of FIG. 1A.

A root cause inspector 130 may be configured to identify, within each directed cluster of events, one or more specific events that should be a focus for correcting the situation, or for avoiding the situation in the future. The root cause inspector 130 may thus be configured to identify an event of a directed cluster of events as a root cause event. In many scenarios, however, identifying a root cause node may be more complex than simply picking an earliest event node within the directed cluster of event nodes.

Thus, the situation identifier 128 and the root cause inspector 130 may be configured to identify a situation and its root cause. Consequently, the administrator or user may be provided with an ability to resolve a situation quickly, efficiently, and reliably.

Moreover, a prediction manager 132 may be configured to utilize captured situation information, root cause information, and resolution information of multiple situations that occur over time, to thereby predict similar situations prior to such predicted situation actually occurring. For example, machine learning algorithms may be trained using the actual situation, root cause, and/or resolution data, so that the trained algorithms may then predict similar situation(s) occurring in the future.

A remediation generator 134 may be configured to determine and execute remediation techniques to address and resolve situations in an automated manner. That is, instead of, or in addition to, the administrator or user taking action to resolve actual situations, or avoid predicted situations, the remediation generator 134 may be configured to do so with little or no human interaction or moderation. For example, the remediation generator 134 may store, or have access to, pre-generated remediation scripts, which may be matched to corresponding situations identified by the situation identifier 128.

In order to provide the landscape manager 102 in an efficient manner, the at least one processor 122 may include a CPU 136 and a GPU 138. Accordingly, the computer-readable storage medium 124 may include a CPU memory 140 and a GPU memory 142.

As referenced above, and described in more detail, below, the GPU 138 and the GPU memory 142 may be used to provide fast parallel processing of the various ML techniques used in conjunction with providing the landscape manager 102, while the CPU 136 and the CPU memory 140 may be used for various overflow operations or to provide lower-cost storage and processing associated with some aspects of providing the landscape manager 102.

For example, the model manager 126 is illustrated as including a primary model repository 144, which may be understood to store the LLM 153 of FIG. 1A, and any other primary model that may be used. An expert model repository 145 may similarly be understood to store multiple expert models, including, e.g., the expert model 155 of FIG. 1A.

A model handler 148 may thus be configured to select, load, and otherwise manage various combinations of a primary model (e.g., the LLM 153) and one or more expert models (e.g., the expert model 155), in order to obtain a desired type of analysis or other result. For example, when not in use, one or more of the primary model(s) and/or the expert model(s) may be stored using the CPU memory 140.

Then, the model handler 148 may provide functionalities of, e.g., the situation identifier 128, including loading the LLM 153 from the primary model repository 144 in the CPU memory 140 to the GPU memory 142, and, similarly, by loading the expert model 155 from the expert model repository 145 in the CPU memory 140 to the GPU memory 142.

More generally, the model manager 126 may be configured to swap or copy any required expert model 155 from the expert model repository 145, e.g., stored using the CPU memory 140, to the GPU memory 142 for execution using the GPU 138. For example, if the root cause inspector 130 has a separate expert model, the model handler 148 may be configured to provide that expert model to the GPU memory 142 for determination of a root cause of a situation. Similar comments would apply for expert models corresponding to the prediction manager 132 and/or the remediation generator 134, or for any expert model that may be stored using the expert model repository 145.

If the GPU memory 142 reaches a maximum quantity of memory available for storing expert models, then the model handler 148 may be configured to remove one or more expert models when loading a new expert model. For example, the model handler 148 may be configured to remove a least-recently used expert model to create space for a newly loaded expert model.

During execution of an expert model 155 by the GPU 138, in conjunction with a corresponding primary model, a memory manager 150 may be configured to make efficient use of the GPU memory 142. For example, the memory manager 150 may implement one or more caching techniques, e.g., in the context of a shared memory pool that is shared across multiple expert models currently stored in the GPU memory 142. Accordingly, resources of the GPU 138 and the GPU memory 142 may be used efficiently, and a speed with which results are obtained from a primary model and corresponding expert models may be increased. Additional discussion of example caching and memory-sharing techniques are provided below, e.g., with respect to FIG. 6 and FIGS. 11-15.

With respect to the incremental training engine 160, and as referenced with respect to FIG. 1A, the incremental training engine 160 may be configured to train, for a given expert model, a training model instance of the given expert model, using, e.g., most-recent training data of the training data 162. For example, for an expert model that has been deployed for a preceding calendar year (January-December), a separate training model instance may be trained at the end of a subsequent January, using corresponding training data. The resulting, trained instance may then be combined with the original expert model to obtain an incrementally updated version of the expert model that takes into account most-recent training data.

For example, In FIG. 1B, the incremental training engine 160 is illustrated as including a training data handler 164, a validation manager 166, and a model merger 168. The training data handler 164 may be configured to input the most-recent training data (e.g., from the current January data) and clean, filter, organize, verify, or otherwise process or pre-process the training data.

The validation manager 166 may be configured to validate hyperparameter 151 selection, fine-tuning of the training instance, and determination of model weights and other parameters. Then, the model merger 168 may be configured to merge the training instance of the expert model with the existing expert model, e.g., by adjusting the weights of the existing expert model using the determined weights of the training instance. Additional details and examples of operations of the incremental training engine 160 are provided below, e.g., with respect to FIGS. 3-5.

FIG. 2A is a flowchart illustrating example operations of the incremental training engine 160 of FIGS. 1A and 1B, and FIG. 2B is a flowchart illustrating example operations of the model manager 126 of FIGS. 1A and 1B. In the example of FIGS. 2A and 2B, operations are illustrated as separate, sequential operations. In various implementations, the illustrated operations may include sub-operations, may be performed in a different order, may include alternative or additional operations, or may omit one or more operations. Further, in all such implementations, included operations may be performed in an iterative, looped, nested, or branched fashion.

In FIG. 2A, network data may be analyzed using a combination of a primary model and a secondary model to obtain first network analysis results (202a). For example, with reference to FIGS. 1A and 1B, the metrics 118 of the IT landscape 103 may be analyzed using a deployed primary model from the primary model repository 144 and an expert model (as the secondary model) from the expert model repository 145. For example, the primary model may include the LLM 153 of FIG. 1A, and the expert model may include the expert model 155 of FIG. 1A, including one or more suitable topological context adapter(s) 154 and associated hyperparameters 151. As described below in detail, the topological context adapter(s) 154 may include a set of weights that enable processing of the network data to thereby obtain the corresponding network analysis results. The weights may have been determined using historical training data from the training data 162. Continuing the specific example from above, the historical training data may include training data from a preceding calendar year, and the network data and the first network analysis results may be processed in January of the subsequent year.

A training instance of the secondary model may be trained using the network data and the first network analysis results (204a). For example, the training data handler 164 and the validation manager 166 of the incremental training engine 160 may be configured to process network data and associated analysis results from the subsequent January, or from any recent and defined time period, to train the training instance. As the defined time period (e.g., data from the month of January) is relatively brief and the secondary model is relatively small and specialized (e.g., has many fewer weights than the associated primary model), it is possible to train the training instance quickly and efficiently.

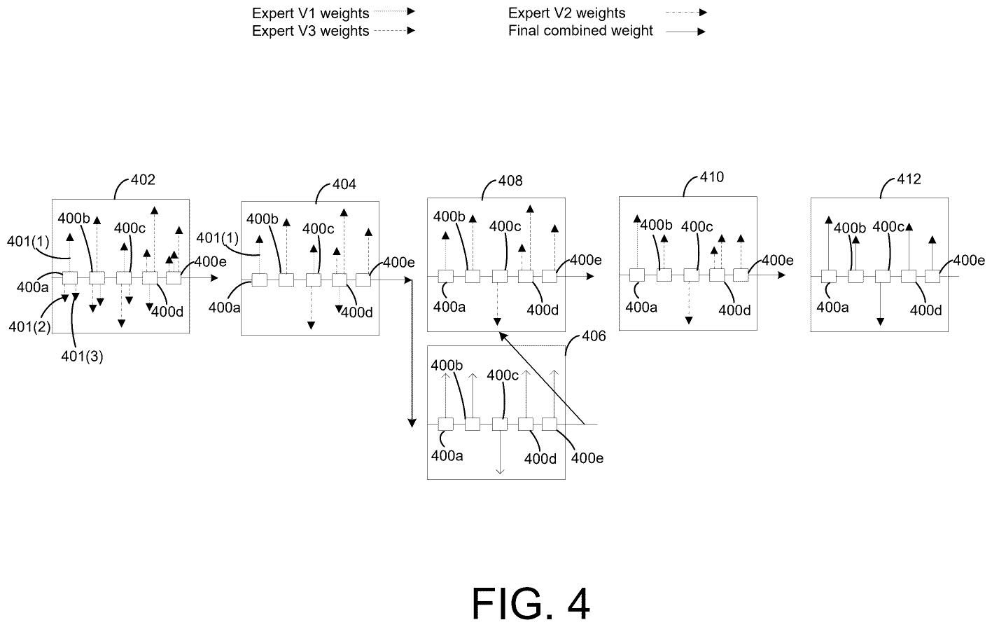

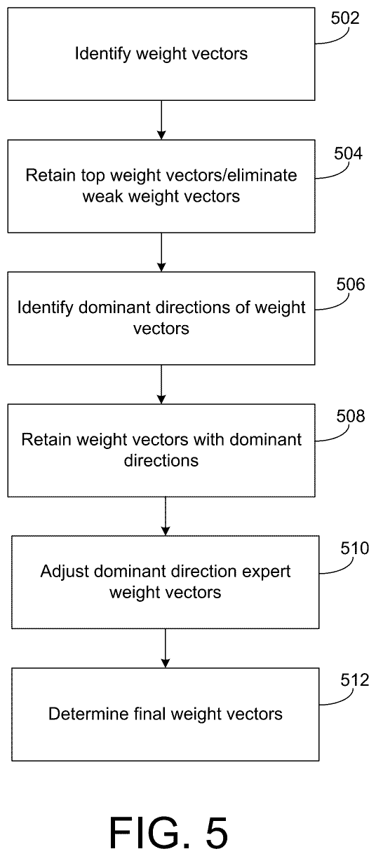

The secondary model may then be updated using the training instance to obtain an updated secondary model (206a). For example, as referenced above and described in detail below with respect to FIGS. 4 and 5, the training instance may be merged with the secondary model by adjusting weights of the secondary model based on weights of the training instance. For example, specific weights (or aspects thereof, such as a magnitude and/or direction of change of one or more weights) determined to be most impactful when determining the network analysis results may be used to adjust corresponding weights of the secondary model, to thereby obtain the updated secondary model. As the training instance and the secondary model are relatively small (have relatively few weights) as compared to the primary model, such an approach may be implemented more quickly and efficiently than performing traditional types of retraining and fine-tuning of the secondary model using an entirety of the existing and new training data.

Additional network data may thus be processed using a combination of the primary model and the updated secondary model (208a). For example, the updated secondary model may be stored as a new version of an earlier expert model in the expert model repository 145 and may be loaded into the GPU memory 142 by the model handler 148 in response to a request or other determination of a need for processing corresponding type of network data.

In FIG. 2B, network data of a first type may be analyzed using a primary model and a first secondary model, the first secondary model trained to process the network data of the first type (202b). For example, a primary model of the primary model repository 144 may be initially loaded to the GPU memory 142 with an expert model (from the expert model repository 145) that enables operations of the situation identifier 128, as described above, so that the first type of network data may include events determined from the metrics 118 and/or associated topology data.

A request to analyze network data of a second type may be received (204b). For example, a request to generate a remediation may be received, which may require use or operation of the remediation generator 134. In such cases, the second type of network data may include one or more recognized situations for which a corresponding root cause(s) has been determined, so that a suitable remediation may be generated. Many other examples of different types of network data, and associated expert models, may be used, such as expert models for incident ticket data or log record analysis. As illustrated with respect to FIG. 6, multiple expert models may be stored together within the GPU memory 142, to thereby analyze various corresponding types of network data.

The first secondary model may be swapped with a second secondary model trained to process the network data of the second type (206b). For example, referencing FIG. 1A, the LLM 153 may represent the primary model, and the expert model 155 may represent the first secondary model. Then, a second expert model may be swapped with the expert model 155, including, e.g., different topological context adapter(s) and hyperparameters 151.

Accordingly, the network data of the second type may be analyzed using the primary model and the second secondary model (208b). For example, continuing the example from above, the new expert model replacing the expert model 155 may process a new or second type of network data in combination with the LLM 153.

FIG. 3 is a block diagram illustrating a more detailed example of incremental training that may be used in the systems of FIGS. 1A and 1B. In the example of FIG. 3, it is assumed that one or more LLMs are stored in a global LLM repository 302. Such LLMs may be trained using generic or widely applicable or available network data likely to be common to many different network environments. As a result, by itself, each such LLM may provide useful functionality across many different network environments. At the same time, by itself, each such LLM may be unlikely to provide the type of particular analysis of network data that might be needed in a specific context(s).

For example, in the context of FIG. 3, the term tenant is used to refer to one or more users and associated environments in which LLM(s) of the global LLM repository 302 may be deployed and adapted using techniques described herein. For example, the global LLM repository 302 may be supplied by a provider, and a tenant may represent one or more businesses or other customer of the provider. Even when such tenants have overlapping or similar business concerns, differences will exist with respect to the environment of each tenant, such as differences in network topologies, terminologies, and various use case scenarios.

Therefore, one or more desired LLMs from the global LLM repository 302 may initially be deployed within a tenant environment 304 and stored using a tenant LLM repository 306. Each included tenant LLM may include, or be associated with, one or more expert models that include one or more context adapters and associated hyperparameters, where such model parameters may initially be set to default or best-guess values. Each included tenant LLM may be deployed to provide initial processing of network data within the tenant environment 304, including the various types of network data described herein (e.g., event and/or situation analysis, incident ticket and/or helpdesk analysis, or log record analysis), or various other types of network data.

Resulting network analysis may provide useful and helpful information within the tenant environment, which may be improved over time through the use of incremental training techniques described herein. For example, a tenant training environment 308 may collect training data within a tenant training data repository 310, where such training data includes data records with network data analyzed together with corresponding network data analysis results obtained using a corresponding LLM from the tenant LLM repository 306.

Such training data records are accumulated over time, and corresponding incremental training job invocation 312 of the underlying tenant LLM(s), e.g., of included expert models, may occur or be initiated. For example, such invocation may occur at defined intervals, or when a certain number of relevant data records have been accumulated. In some examples, invocation may occur based on a rate of data records obtained, e.g., when more than ‘n’ records are accumulated for more than ‘x’ time period(s).

Resulting invocation results in tenant training data 314 being provided for use in incrementally training corresponding expert models of the LLMs of the tenant LLM repository 306. By way of example, in the following description of FIGS. 3-5, the example scenarios described above are described in further detail, with assumptions that training data collection and subsequent incremental training invocations occur on a monthly basis. For example, incremental training data collected in January may be used to incrementally train expert models of the LLMs of the tenant LLM repository, which may have been recently deployed from the global LLM repository 302 or which may have been already incrementally trained over some preceding time period (e.g., over a preceding year) following deployment from the global LLM repository 302.

Similarly, incremental training data collected in February, March, and ensuing months may be used to continue incremental training over time. For example, training data of each month may be used individually for incremental training, and training data over multiple months may be used to infer or determine trends over multiple training increments or periods.

In the example of FIG. 3, the tenant training data 314 may thus be used to initiate training of a training instance of an expert model of a tenant LLM of the tenant LLM repository 306. As described herein, such a training instance may be trained relatively quickly, easily, and efficiently, because the training instance is relatively small, has relatively few weights, and uses a relatively small amount of training data (e.g., a month's worth of training data).

As described with respect to FIG. 1B, tenant training data 314 may initially be processed by the training data handler 164 of FIG. 1B. For example, such data handling may include data verification 316. For example, data verification 316 may include inspection of the tenant training data 314 for empty and/or null data and/or for duplicate records, in order to filter or remove such data and thereby facilitate training efficiency. Any mandatory data or data structure(s) may be verified, as well.

Training data handling may further include data pre-processing 318. Such data pre-processing 318 may include identification or characterization of entropy (e.g., measure of uncertainty in information content) of the training text, normalization of the training data to a uniform notation (e.g., for dates or timestamps) and/or filtering of the training data to remove, e.g., identified stop words, tenant-specific content including personally identifying information, or modifications reflecting other tenant feedback.

Training data handling may further include dataset management 320. Such dataset management 320 may include, e.g., modifying data formats to be compatible with the corresponding primary and/or expert model(s). Data from different sources may be merged to format LLM prompts for instruction and/or response pairs.

During data split and sampling 322, rating and ranking of data may be performed to determine which data should best be used for incremental training purposes. For example, ranking and/or extracting LLM functions may be used to identify training data that may best (e.g., most easily) be used during subsequent training efforts. For example, incident ticket data may be ranked based on whether each incident ticket includes meaningful and/or actionable descriptions of incidents and/or of remediations. Selected training data may then be split into a training data set (e.g., 90% of the training data) and a validation data set (e.g., 10% of the training data) that is reserved for validating training results or may be split into other weighted percentages of training data to validation data.

During hyperparameter selection and validation 324, a selection of suitable architecture(s) for expert model adapters to be trained may be made, and suitable adapter and model training parameters may be selected, e.g., based on relevant hardware being used and associated expert model(s) being trained. For example, the training data may be split so that portions of the training data are assigned to corresponding types of expert models (e.g., situation identifier or incident ticket and/or helpdesk expert models). Training data may also be classified and/or labeled based on a task to be performed, such as, e.g., generating code, summarizing text, or summarizing a graph, so that a corresponding adapter may be selected.

Each expert model being trained may be provided with individual hyperparameter(s) that provide global setting(s) for the corresponding expert model. Unlike model parameters such as weights, hyperparameters do not change during normal training, but rather are external to the model being trained, are set prior to training, and may govern aspects of the training process. Hyperparameters may include, e.g., model size, sampling characteristics, learning rate, temperature, rank, or various other type of hyperparameters. In general, examples of such hyperparameters may be known, and potential hyperparameters and example implementations thereof are not necessarily described herein except as may be helpful in understanding various specific example implementations. For purposes of FIG. 3, it should be appreciated that the ability to select and customize hyperparameters for individual expert models provides an ability to adapt individual expert models to desired use cases (areas of expertise) in a highly targeted and individualized manner.

Quantized supervised fine-tuning 326 may then be performed separately on each expert model training instance, e.g., by keeping the primary model intact (e.g., weights frozen) while only training expert model parameters. Advantageously, quantizing the fine-tuning enables training using a 4-bit architecture rather than a full floating point, e.g., 32-bit architecture, which is made possible in part by use of relatively small models with correspondingly small numbers of weights. As a result, models may be trained quickly, using less GPU/GPU memory resources, and/or using less expensive hardware.

Validation metrics may then be checked 328 with respect to both the training data set and the validation data set. By measuring validation metrics 330 at such checkpoints, the expert model training instance being trained may be evaluated and decisions regarding persisting the model may be made. As shown, example validation metrics may include validation set results, perplexity (e.g., measure of uncertainty of model prediction) of fixed-length models, training and validation losses, or evaluation algorithms (e.g., the bilingual evaluation understudy (BLEU) algorithm or the ROUGE algorithm(s)) may be used 330.

Model checkpoints 332 may be used due to the relative lack of fault tolerance in some GPUs. Final model weights per version 334 of each expert model training instance may be persisted, again subject to consideration of the various model metrics 330.

Model merging strategies 336 across versions may then be implemented, as referenced above and described in more detail, below, with respect to FIGS. 4 and 5. For example, rather than simply adding the newly obtained (e.g., most recent month(s)) training data to a corpus of existing training data and retraining a LLM, described techniques enable identifying a most-relevant subset of weights of the training instance of the expert model(s), and then adjusting corresponding weights of the existing expert model(s) to incrementally train the expert models.

During post-training quantization and/or versioning 338, the training data may be identified as being versioned across multiple time periods, e.g., January, February, and March in the above example scenarios, and as continued in the example scenarios of FIGS. 4 and 5, below. By versioning over multiple time periods, individually and in combination, trends may be utilized and optimized training data (and correspondingly optimized expert models) may be provided. For example, training data from January, February, and March may be processed as individual months, pairs of months (e.g., January/February or February/March), or as an entirety (e.g., January/February/March).

Resulting incrementally trained expert models may again be evaluated relative to the validation metrics 330. Upon successful completion of validation 340, resulting validated model(s) may be uploaded with final versioning to the tenant LLM repository 306.

Thus, it will be appreciated with respect to FIG. 3, and generally in the present description, various training processes and aspects that may be conventional or known with respect to training LLMs or other suitable ML models may not be described here in detail. Rather, FIG. 3 demonstrates that such processes may be used together with described incremental training techniques to provide the various advantages thereof that are described herein.

FIG. 4 is a block diagram illustrating example weight adjustments that may be made at different times 402, 404, 406, 408, 410, and 412 in the example of FIG. 3. FIG. 5 is a flowchart illustrating example operations for the weight adjustments of FIG. 4.

More specifically, the simplified example of FIG. 4 illustrates five example weights 400a, 400b, 400c, 400d, and 400e of an expert model. Of course, the expert model will have many more weights than these five examples, but will have significantly fewer weights than an underlying primary model (e.g., the primary model may include a thousand times or more weights than the expert model has), so that, as described, the types of adjustments described with respect to FIGS. 4 and 5 are feasible.

The weights 400a, 400b, 400c, 400d, 400e represent floating point numerical values that, e.g., have been established or calculated as a result of earlier training processes. For example, in the various examples above, the expert model may have been trained using training data of a preceding year, to thereby obtain the weights 400a, 400b, 400c, 400d, 400e.

Then, following a subsequent January, a training instance of the expert model may be trained as a first training instance version, referred to in FIG. 4 as expert version 1, or V1. Similar comments apply to a second training instance version that is based on February data and referred to as expert version 2, or V2, and to a third training instance version that is based on March data and referred to as expert version 3, or V3.

Each such training instance version may include corresponding values for the weights 400a, 400b, 400c, 400d, 400e, which may be increased or decreased. That is, a weight such as the weight 400a may have a certain value in the original expert model, but may have a larger value in the V1 data and smaller values in the V2 and V3 data. Such changes may be relatively large or small, or a given weight value may not change at all.

Such changes are represented in FIG. 4 using dashed arrows in accordance with the provided key. Thus, for example, the weight 400a is illustrated as demonstrating an increase or positive change during January (V1), as indicated by an upwards arrow 401(1). Further, the weight 400a is illustrated as demonstrating a decrease or negative change during February (V2) and an even larger decrease or negative change in March (V3), as indicated by respective downwards arrows 401(2) and 401(3). A strength or magnitude of each such change is represented by a length of each arrow. As each such change therefore has a magnitude and a direction, in the following description, the various weight changes represented by arrows 401(1), 401(2), and 401(3), and the various other illustrated arrows, are referred to as weight vectors.

With reference to both FIG. 4 and FIG. 5, processing begins with determining all such various weight vectors across the different versions of the trained training instances, as shown at time 402 of FIG. 4 and at operation 502 of FIG. 5. Then, weight vectors below a defined strength threshold may be removed, as shown at time 404 of FIG. 4 and at operation 504 of FIG. 5 For example, with respect to weight 400a, weight vectors 401(2) and 401(3) are below the threshold and have been removed, leaving weight vector 401(1) intact. Weak weight vectors of the weight 400b, 400c, 400d and 400e, not separately enumerated, are also removed. Put another way, the top k or k % weight vectors in strength may be retained across the weights 400a, 400b, 400c, 400d, 400e, while remaining weight vectors are eliminated.

At a time 406 of FIG. 4, and at operation 506 of FIG. 5, a dominant direction of weight vectors for each of the weights 400a, 400b, 400c, 400d, 400e may be determined. For example, as shown, the weight 400a retains only the weight vector 401(1), and therefore a dominant direction of change is identified as weight increase, as shown by the positive arrow associated with the weight 400a at the time 406. Similar comments apply to weights 400b and 400e. Weight 400c demonstrates both positive and negative weight vectors, with the negative weight vector having a larger magnitude, so that a dominant direction of the weight 400c is negative. Weight 400d also demonstrates positive and negative weight vectors, but with the positive weight vectors having a total larger magnitude, so that a dominant direction of the weight 400d is positive.

In other implementations, it may be possible to retain an aggregated change in weight direction, rather than the type of dominant direction identification just described. For example, the weight vectors 401(1), 401(2), 401(3) may be aggregated to determine a total change of the weight 400a. In such approaches, however, it may occur that the aggregate change over multiple versions may be zero or close to zero, i.e., the values of the multiple weight vectors may effectively cancel out with respect to an underlying weight. In such cases, when later adjusting the corresponding weight in the underlying expert model, a value of the corresponding weight in the underlying expert model may go unchanged, which may not be reflective of changes captured by the various training instances.

At time 408, and at operation 508 of FIG. 5, dominant direction expert weights are retained. For example, the negative weight vector of the weight 400c is retained while the positive weight vector is eliminated. Similarly, the two positive weight vectors of the weight 400d are retained, while the negative weight vector is eliminated.

At a time 410, and at operation 510 of FIG. 5, the dominant direction expert weights may be adjusted to reflect factors associated with the training data of each training instance version, alone or relative to one another, and/or with respect to the underlying expert model training data. For example, it may occur that one training data set is much larger than remaining version data sets and/or was collected over a shorter period of time.

Therefore, rather than using absolute values of the various weight vectors, adjustments may be made based on weighted averages determined by, e.g., data recency and data scale. As a result, determined values may be assured of having effective and proportional changes on corresponding weight values of the underlying expert model. For example, in FIG. 4, due to assumed differences in training data such as those referenced above, but not separately illustrated or described with respect to FIG. 4, expert version 1, V1, weight vectors are proportionally increased, while expert version 3, V3, weight vectors are proportionally decreased, and expert version 2, V2, weight vectors are largely unchanged.

At a time 412, and at an operation 512 of FIG. 5, the final combined weights may be determined. For example, weights 400a, 400b, 400c, and 400e each have only a single weight vector, which is then retained as the final weight vector. Weight 400d retains two weight vectors at the time 410, which are aggregated to provide a final weight vector at time 412.

Consequently, the retained final weight vector values enable operations of the model merger 168 of FIG. 1B, the updating operation(s) (206a) of FIG. 2A, or the model merging strategies 336 of FIG. 3. In other words, as described, a given expert model may be incrementally trained and updated using individual versions of training instances generated using most-recent data, so that the resulting, adjusted and/or updated expert model is consistently current, up-to-date, and reflective of recent changes to an IT landscape being monitored, without having to re-train and fine-tune the expert model (or the underlying primary model) entirely.

Thus, FIGS. 4 and 5 illustrate that incremental and historical expert model updates may be executed by constructing weight vectors derived from the existing expert weights and incremental expert weights. Redundant weight updates may be addressed by retaining only the top k % of weights based on magnitudes. Not explicitly shown in FIG. 4, remaining expert parameter weights may be further pruned, ensuring a focused representation of salient features for model adaptation, τₜ=γₜ⊙μₜ, in which γₜ denotes the retained weights after magnitude-based selection, and μₜ signifies the pruned weights set to zero.

Following the initial refinement, signs for each weight vector may be determined, e.g., by computing the total magnitude in both positive and negative directions for each weight. The direction exhibiting the highest aggregate magnitude is then selected, and the corresponding sign is assigned to the parameter. γ^{p}ₘ=sgn(Σ^{m}ₜ₌₁τ₁^{p}) Here, γ^{p}ₘ represents the selected sign for parameter pp in the merged model.

Subsequently, the weights from the identified directions are amalgamated to derive the final weights. As in the examples of FIGS. 4 and 5, above, only those directions consistent with the selected signs may be retained. This aggregation process involves summing the weights from matching directions to obtain the final combined weights. τ^{p}ₘ=1/|A^{p}|Σ_{t∈Ap}τₜ^{p} Here, A^{p} denotes the set of models contributing to parameter p with matching signs, and τ^{p}ₘ signifies the aggregated weight for parameter pp in the merged model.

Finally, the resulting combined weights are merged with the base model using a scaling factor, e.g., a hyperparameter that governs the extent of integration. This ensures the seamless incorporation of incremental and historical expert updates into the existing model framework, thereby facilitating continuous learning and adaptation.

FIG. 6 is a block diagram of an example implementation of the system of FIG. 1B. FIG. 6 provides an example implementation provided by the model manager 126 of FIG. 1B, including providing example instances of the operations of the flowchart of FIG. 2B.

As shown, a main memory 602 (e.g., CPU memory) and a GPU memory 604 may be used to optimize storage and use of various expert models, as described with respect to the CPU memory 140 and the GPU memory 142 of FIG. 1B. As further illustrated, the main memory 602 is shown as storing an expert model 606, an expert model 608, an expert model 610, an expert model 612, an expert model 614, and an expert model 616.

As described with respect to FIGS. 1B and 2B, resources of the GPU memory 604 may thus be retained by using available portions of the GPU memory 604 only for active (e.g., currently or recently used) expert models. For example, when needed or requested, expert models may be fetched from the main memory 602 to perform specified processing.

In the example of FIG. 6, the expert model 610 and the expert model 612 are illustrated as having been fetched and are shown in the GPU memory as expert model 610a and expert model 612a. For example, the expert models 610a, 612a may be copied from the main memory 602 to the GPU memory 604 as needed.

Although only the two expert models 610a, 612a are illustrated as being stored in the GPU memory 604 in FIG. 6, it will be appreciated that a pool of expert models may be maintained using the GPU memory 604, depending on a total quantity of GPU memory resources that are available. When a given expert model in such a pool has not been used for a defined quantity of time it may be removed from the GPU memory 604. Similarly, if a maximum number of expert models within such a pool is reached, then a subsequently loaded expert model may cause removal of an expert model that has been least-recently used.

As described herein, each expert model loaded to the GPU memory 604 may be executed in conjunction with an underlying primary model, where primary model weights 618 of such a primary model are illustrated in the GPU memory 604 in FIG. 6. That is, as described in more detail below with respect to FIGS. 7-15, weights of the individual expert models 610a, 612a may be processed together, as needed, with the primary model weights 618, to provide desired analysis results.

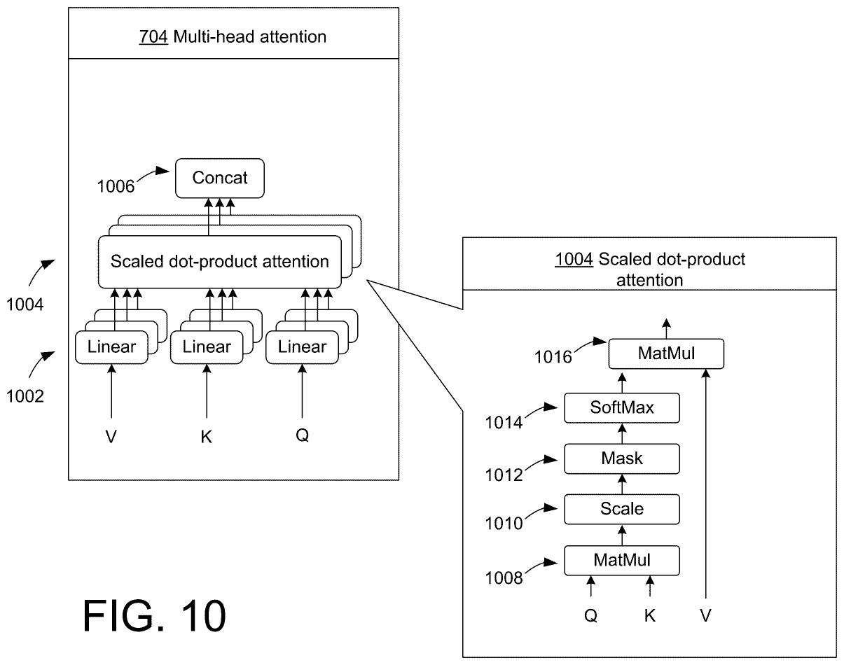

In order to provide such processing in an efficient manner, a shared memory pool 620 may be defined within the GPU memory 604. Further, a key-value (KV) cache 622 may be established within the shared memory pool 620. As described below with respect to FIGS. 10-15, the KV cache 622 may be used to store previously calculated values that will be useful for subsequent calculations, to thereby avoid the need (and use of resources) to re-calculate those values during the subsequent calculations.

Although the use of caching techniques in general may be known in related contexts, e.g., in LLM processing, such caching techniques do consume resources of the GPU memory 604 (and associated GPU), so that a value of such caching provides diminishing returns as a size of a model(s) being processed increases. In described examples, however, the various expert models are relatively small, so that corresponding caching provides a relatively large benefit at the cost of a relatively small quantity of the GPU memory 604. Moreover, the shared memory pool 620 enables sharing of the KV cache 622 across multiple expert models, as shown in FIG. 6 with respect to the expert models 610a, 612a, which further increases a utility and efficiency of described techniques.

FIG. 7 is a block diagram of an example transformer layer 702 that may be used to implement the system of FIG. 1A. More specifically, for example, the transformer layer 702 may be included in the LLM 153 of FIG. 1A. Other portions of the LLM 153, by themselves, are known and are not described here in further detail, except as needed to understand described techniques.

In general, transformer layer(s) of a LLM, such as the LLM 153 (or 153c, 153d) are designed to convert a type of input into a desired type of output. For example, in the context of language translation, transformer layers may be used to translate English sentences into Spanish sentences or perform any desired translation.

For example, the transformer layer 702, and/or preceding layers of the LLM not explicitly shown in FIG. 7, may be configured to receive textual inputs and provide corresponding embeddings and positional encodings. For example, a received sentence may be assigned an embedding for each word, as well as a positional encoding for a position of each word within the sentence.

A multi-head attention layer 704 may be configured to determine internal relationships between elements of the input text. For example, the concept of attention in the context of the transformer layer 702 may refer to determinations of relationships between words in a sentence, or among different sentences. Consequently, attention enables disambiguation of words, relationships between pronouns and their corresponding antecedents, entity identification, and general awareness of relative levels of importance of individual words or phrases within the context of the overall input text. In FIG. 7, the term multi-head generally refers to the use of multiple different types of attention mechanisms and associated areas of focus (e.g., shorter-term dependencies or longer-term dependencies) within the input text. In this way, multiple types of attention may be calculated in parallel for improved processing efficiencies.

As further shown in FIG. 7, the inputs of the multi-head attention layer 704 (e.g., word embeddings and positional encodings) may be combined with the outputs of the multi-head attention layer 704, in a process known as a skip connection. Such a skip connection maintains information regarding the input embeddings and/or encodings that might otherwise be lost during the attention calculations, while also facilitating backpropagation operations during training of the transformer layer 702.

The combined inputs and outputs of the multi-head attention layer 704 may then be fed to a normalization layer 706. Such normalization restricts a range of the received, aggregated values, which, e.g., avoids overly large values that can lead to training errors, and generally facilitates determinations of optimal values during back propagation processes, e.g., by keeping available values within a known range. FIG. 7 illustrates an example of layer normalization, in which normalization is applied on a layer-by-layer basis within a neural network being processed, but other types of normalization may be used, as well.

A feed-forward layer 708 refers to a feed-forward network, including an input layer, desired number of hidden layer(s), and an output layer. The feed-forward layer 708 includes edges between the various nodes of the aforementioned layers that are assigned corresponding weights and biases, along with an activation function associated with the nodes. Then, as described above, a residual or skip connection enables a combination of the inputs and outputs of the feed-forward layer 708, followed by another normalization layer 710.

All of the layers 704, 706, 708, 710 may be processed during training operations to assign values to include weights and any other trainable parameter(s), referred to cumulatively herein as weights. As known for LLM transformers such as the transformer layer 702, and as referenced above, such training may be conducted using parallel operations and corresponding parallel processors/processing, to process large amounts of training data. Using such techniques, a conventional transformer may be trained (i.e., weights may be assigned to the various layers 704, 706, 708, 710), to, e.g., provide useful summaries of received text.

Such summaries are available only for received text when using text adapters, whereas, in FIG. 7, a topological context adapter 712, representing an example of the topological context adapter(s) 154 of FIG. 1A, may be added to the illustrated transformer pipeline. As shown, a topological context adapter 712 is positioned following the multi-head attention layer 704, while a topological context adapter 714 is also added following the feed-forward layer 708. Such topological context adapters 712, 714 thus enable processing of the event graph 146a or other graph representations of network situations.

For example, the topological context adapters 712, 714 may be configured to input and process graphs, such as the event graph 146a, together with event text (shown as event text 146c in FIG. 1A). For example, the transformer weights of the layers 704, 706, 708, 710 may be frozen or held at constant values determined from previous training, while adapter weights of the topological context adapters 712, 714 are updated during a subsequent fine-tuning training process that includes training performed with respect to event graphs, topology graphs, and/or knowledge graphs.

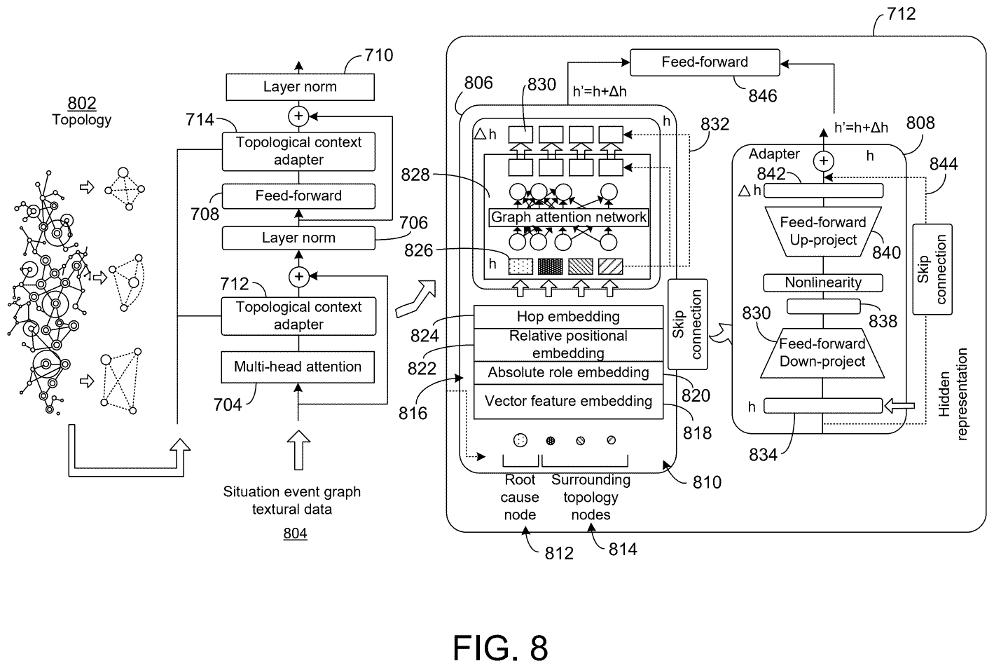

More specifically, as shown in FIG. 8, graph data 802 may be provided to the topological context adapters 712, 714, while event graph text 804 is provided as input to the multi-head attention layer 704. FIG. 8 further illustrates an exploded view of the topological context adapter 712.

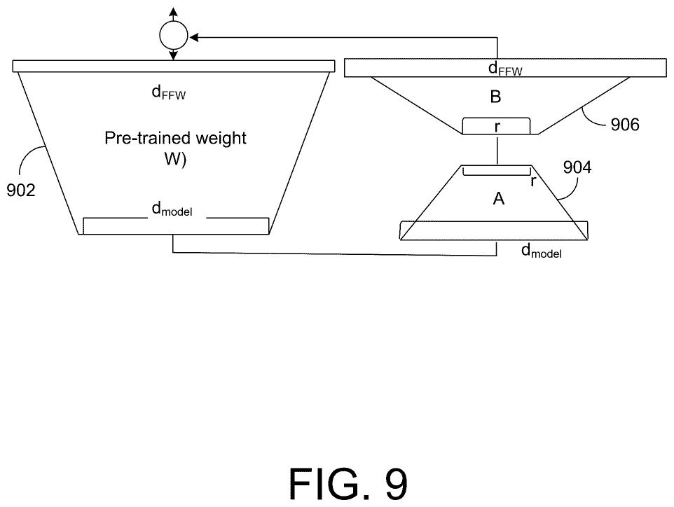

As illustrated in FIG. 8, and as referenced earlier in the examples of FIGS. 2A and 2B, the topological context adapter 712 includes a graph adapter 806 and a text adapter 808. The graph adapter 806 may be trained and otherwise configured to process graph data, as just referenced. Meanwhile, the text adapter 808 represents any suitable network suitable for processing text, specific examples of which are provided with respect to FIGS. 8 and 9. In the following description, the term adapter weights is used to refer collectively to all weights of the topological context adapter 712, while the term graph adapter weights refers to weights of the graph adapter 806, and the term text adapter weights refers to weights of the text adapter 808.

As illustrated and described with respect to FIG. 8, both the graph adapter weights and the text adapter weights may be trained together (and with corresponding adapter weights of the topological context adapter 714), while remaining transformer weights of the layers 704, 706, 708, 710 are held frozen at previously determined values. Consequently, such training of the graph adapter weights may be performed in a customized, efficient manner.

In FIG. 8, an event graph 810, including a root cause node 812 and surrounding topology nodes 814, is illustrated as being input to the graph adapter 806. More specifically, the event graph 810 is illustrated as being input to graph embedding layers 816. As described in detail, below, the graph embedding layers 816 may include one or more layers for determining an embedding of the event graph 810, so that the resulting graph embeddings may be processed by a graph attention network 828.

In the example of FIG. 8, the graph embedding layers 816 include a vector feature embedding layer 818. Conceptually, the vector feature embedding layer 818 is designed to capture node features of individual nodes of the event graph 810. For example, node features may include, for a given node, an associated device type (e.g., router, switch, or load balancer), application, or business service, as well as associated details that may be specific to the individual device (e.g., network interface characteristics). As referenced above, some device features may be determined from corresponding topology data and/or knowledge graph(s).

Then, the vector feature embedding layer 818 may be configured to convert such node features into a corresponding embedding(s), providing a numerical representation of the above-referenced types of node features, in which similar node features will be embedded close to one another within the vector space of the embeddings. For example, nodes for two different types of routers may have similar vector feature embeddings, while a node for a virtual machine and a Kubernetes port may have dissimilar vector feature embeddings.

In an example formal representation, for each node vⱼ∈Vi in the subgraph gᵢ, a raw feature vector can be embedded into a shared feature space (of the same dimension dₕ) with its raw feature vector xⱼ, which can be denoted as:

$${e}_{j}^{( x )} = Embed ( {x}_{j} ) ∈ R dh \times 1$$

An absolute role embedding layer 820 may be configured to embed features related to a role of a node within a graph. For example, a node's role may relate to various types of graph invariants, such as vertices, edges, and degree. For example, a graph node may provide the role of a hub, a spoke, or a leaf node. Therefore, for example, a hub node with many edges will have an absolute role-embedding aspect similar to another hub node with a number of edges, and both may have dissimilar embeddings with respect to a leaf node with a single edge.

The Weisfeiler-Lehman (WL) algorithm may be used to label the nodes according to their structural roles in the graph data, with nodes having identical roles being labelled with the same code. Formally, for node vⱼ∈Vᵢ in the sampled subgraph, its WL code can be denoted as WL(vⱼ)∈N, which can be pre-computed based on the complete graph and is invariant for different sampled subgraphs:

$${e}_{j}^{( r )} = Embed ( WL ( {v}_{j} ) )$$

A relative positional embedding layer 822 determines embeddings based on relationships between nodes, i.e., based on relationships between underlying devices, interfaces, applications, services, or other node features, as well as relative orders or sequences of the nodes and features. For example, a relative positional embedding may identify a router connected to an interface, or vice versa, in a causal manner. Thus, for instance, a generated narrative may more easily determine potential causations within an analyzed graph, which may or may not be explicitly reflected within the graph being processed. That is, although various types of causation may be determined and reflected in a graph using the techniques of FIG. 1B, the relative positional embedding layer 822 (similar to other embeddings) may further determine similarities between many different pairs and sequences of nodes across many analyzed graphs, to determine and characterize such relative positions more completely and more accurately.

The WL-based role embeddings referenced above may be used to capture global node role information in embeddings. For example, a relative positional embedding may be introduced to extract local information in a subgraph based on the placement orders of the serialized node list discussed above. Formally, based on that serialized node list, the position of vⱼ∈Vᵢ can be denoted as P(vⱼ). Because P(vᵢ)=0 by default and nodes closer to vi will have a small positional index, and, furthermore, P(⋅) represents a variant position index metric, then for the identical node vⱼ, its positional index P(vⱼ) will be different for different sampled subgraphs:

$${e}_{j}^{( p )} = Position - Embed ( P ( {v}_{j} ) )$$

A hop embedding layer 824 produces embeddings reflecting relative distances between graph nodes. For example, such hop embeddings may capture or characterize whether a pair of nodes are separated by 0, 1, 2, or more intervening nodes. Nodes that are connected by multiple intervening paths (and corresponding numbers of nodes) may also be characterized, and/or a shortest-available connection may be effectively identified.

Hop-based embedding can be treated as a balance between absolute role embedding (for global information) and intimacy-based relative positional embedding (for local information). Formally, for node vⱼ∈Vᵢ in the subgraph gᵢ, relative distance in hops relative to vi in the original input graph may be denoted as H(vⱼ; vᵢ), which can be used to define an embedding vector as:

$${e}_{j}^{( d )} = Embed ( H ( {v}_{j} ; {v}_{i} ) )$$

Calculated embeddings may then be aggregated and passed to an input layer 826 for a graph attention network 828. More specifically, using the computed embedding vectors defined above, initial input vectors for nodes may be defined, e.g., as vⱼ, in the subgraph gi as follows:

$${h}_{j}^{i} = Aggregate ( {e}_{j}^{( x )} , {e}_{j}^{( r )} , {e}_{j}^{( p )} , {e}_{j}^{( d )} ) .$$

The graph attention network 828, similarly in concept to the multi-head attention layer 704, processes input vectors to determine and identify particular nodes, edges, or graph portions for particular attention when generating a narrative or a remediation for the graph being processed. Also similar to the structure and approach of the transformer layer 702, skip connections 832 may be used to provide input values of vector(s) h, at output layers 830.

During training of the graph adapter 806, an error between the generated graph narrative (or remediation) output from the graph adapter 806 may be compared to a labeled, ground truth narrative for the graph being processed, so that an error Ah between the ground truth narrative and the generated narrative may be determined. Then, backpropagation may be used to proceed back through the graph attention network 828 and the graph embedding layers 816, to correct adapter weights (including vector embedding weights) for the graph adapter 806 in a manner that operates to minimize the error Δh. Over many such processing cycles, the error may thus be reduced, and the graph adapter 806 may be trained to conform to corresponding training data. Then, during inference operations, the graph adapter 806 may operate to provide accurate and complete narratives for newly received graphs.

Similar comments apply to the text adapter 808. Specifically, an input layer 834 may be trained to generate a hidden value vector representation for forwarding to a feed-forward down-project 830, for further processing by a nonlinear layer 838 and a feed-forward up-project 840. As with the graph adapter 806, output layer 842 provides an output Ah that may be added to the original value h through skip connection 844 and modified during subsequent backpropagation operations to minimize an error in operations of the text adapter 808. Then, a feed-forward neural network layer 846, similar to the feed-forward neural network layer 708, may be used to combine outputs of the graph adapter 806 and the text adapter 808, for forwarding within the larger pipeline of the transformer layer 702 of FIG. 7.

In the example of FIG. 8, the text adapter 808 utilizes a low-rank adapter (LoRa) approach in which the various model weights are represented as a matrix W of weights, where the matrix W has a degree d that corresponds to the larger LLM of which the topological context adapter 712 is a part. In other words, the matrix W includes the pre-trained weights of the larger LLM, which may advantageously be frozen for purposes of training the topological context adapter 712. The matrix W is not shown separately in FIG. 8, but is represented in FIG. 9 as weight matrix 902.

Such a matrix W may typically have a relatively large dimension d, but may be decomposed into two smaller matrices A and B, shown in FIG. 9 as low-rank matrix 904 (corresponding to the feed-forward down project 830 of FIG. 8) and low-rank matrix 906 (corresponding to the feed-forward up project 840 of FIG. 8). That is, a rank r of the two matrices 904, 906 may be much smaller than a rank of the original matrix W, but may contain a subset of weights of the matrix W that are most pertinent to training the text adapter 808. For example, the matrix W may be decomposed by keeping only linearly independent columns, while removing linearly dependent columns, which retain much of the relevant information needed for subsequent training while greatly reducing a quantity of time and processing resources needed for training.

Then, as understood from FIG. 9, the values of the weights of the matrices 904, 906 may be updated during fine-tuning training, while the pre-trained values of the original matrix 902 are held constant. As shown, the degree d_{model} of inputs to the weight matrix 902 and the weight matrix 904 is the same, while the degree d_{FFW} of the outputs of the weight matrix 902 and the weight matrix 906 to a subsequent feed-forward neural network layer are the same, so that the combination of vectors modified by the weight matrix 902 and the weight matrices 904, 906 may be easily combined.

Further, as the rank r is much less than the rank d, the fine-tuning training may be performed much faster and more efficiently than would be required if the original matrix W were updated. Put another way, a weight after fine-tuning may be written as W₀ (pre-trained weight)+ΔW (updates to the weight), where updates to the weight (ΔW) have a low intrinsic rank, and so that a resulting fine-tuned weight may be provided as W₀+ΔW=W₀+BA, rank r<<min(d_{FFW}, d_{model}).

Thus, FIGS. 7-9 illustrate example uses of various context adapters, various combinations of which may be defined and trained, together with selected hyperparameter values, to define various ones of the expert models described herein. For example, a rank hyperparameter may define a percentage of weights to be trained for a given expert model, which thus limits a corresponding quantity of processing resources required and increases a speed and efficiency of processing data with such an expert model.

FIG. 10 is a block diagram of the multi-head attention layer 704 of FIG. 7. Example layers 1002, 1004, and 1006 of the multi-head attention layer 704 are shown for context and completeness, but descriptions of functions of these layers that are not useful for understanding remaining FIGS. 11-15 are omitted for the sake of clarity and conciseness.

As shown, the multi-head attention layer 704 inputs key (K), value (V), and query (Q) states. Following linear processing at layer 1002, a scaled dot-product attention layer 1004 calculates attention tokens that are concatenated at layer 1006. The exploded view of the scaled dot-product attention layer 1004 illustrates more specifically that Q, K are input through a matrix multiplication layer 1008, a scaling layer 1010, a masking layer 1012, and a softmax layer 1014, after which obtained results undergo matrix multiplication at layer 1016 with the value V.

The processing of the scaled dot-product attention layer 1004 is summarized and illustrated in FIG. 11(without illustrating layers 1010, 1012, 1014 for simplification), in which a first query token 1102, having an embedding size of (1, emb_size) undergoes matrix multiplication with a first key token 1104 of embedding size (emb_size, 1) to obtain a first product 1106 of size (1, 1). As may be understood from the illustration of FIG. 10, the first product 1106 may be multiplied by a first value token 1108 of embedding size (1, emb_size) to obtain a first attention token 1110 of embedding size (1, emb_size).

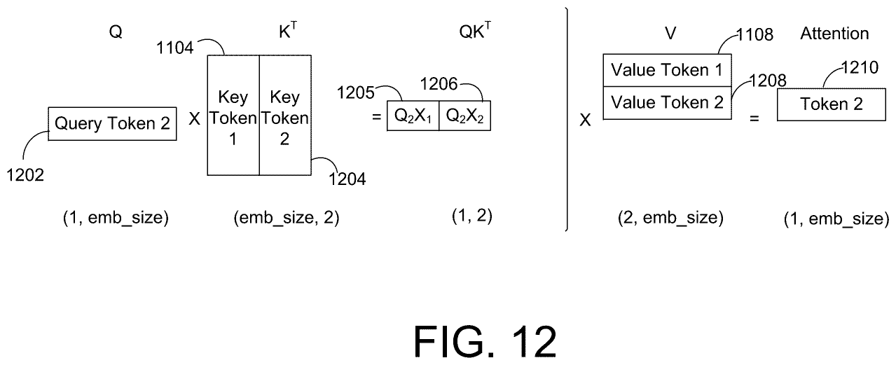

In FIG. 12, a second query token 1202 is processed. In the example, the first key token 1104 of FIG. 11 has been cached using the KV cache 622 of FIG. 6. As a result, the first key token 1104 does not need to be recalculated in FIG. 12, but may simply be retrieved from the KV cache 622. Matrix multiplication may then proceed, this time with embedding size (emb_size, 2), to obtain resulting products 1205, 1206 of size (1, 2). Similarly, the value token 1108 may be cached so that further matrix multiplication using a second value token 1208 and embedding size (2, emb_size) may be executed to obtain attention token 1210 of embedding size (1, emb_size).

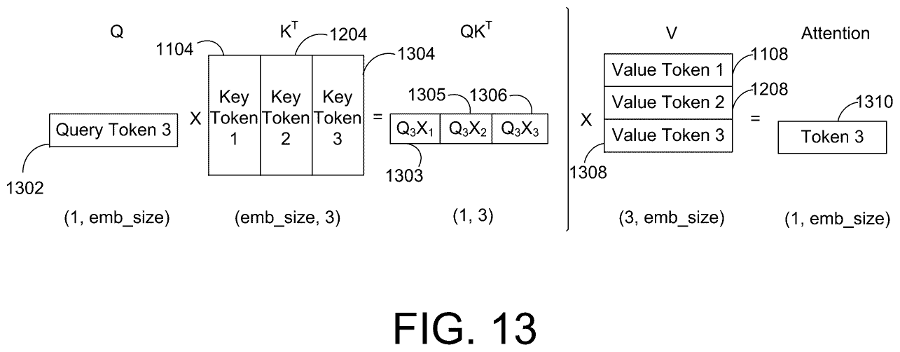

Similar comments apply to FIG. 13, in which a third query token 1302 is processed. In the example, the first key token 1104 of FIG. 11 and the second key token 1204 of FIG. 12 have been cached using the KV cache 622 of FIG. 6. As a result, the first key token 1104 and the second key token 1204 do not need to be recalculated in FIG. 13, but may simply be retrieved from the KV cache 622. Matrix multiplication then may proceed, using third key token 1304 as well, and this time with embedding size (emb_size, 3), to obtain resulting products 1303, 1305, 1306 of size (1, 3). Similarly, the value token 1108 and the value token 1208 may be cached so that further matrix multiplication using a third value token 1308 and embedding size (3, emb_size) may be executed to obtain attention token 1310 of embedding size (1, emb_size).

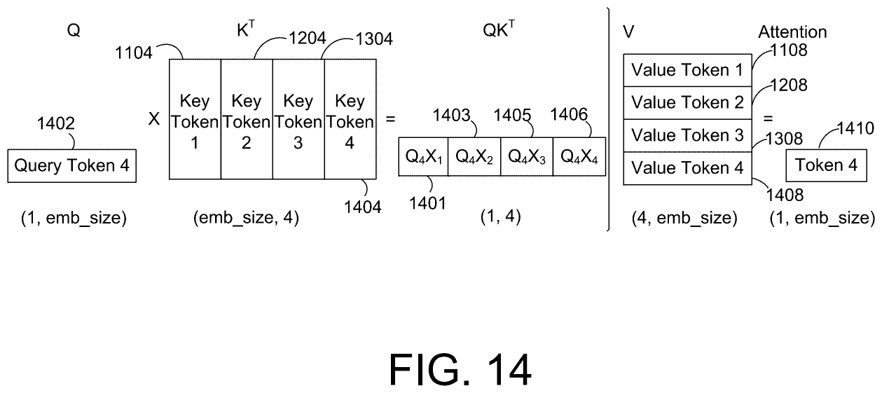

In a final example of KV caching in FIG. 14, a fourth query token 1402 is processed. In the example, the first key token 1104 of FIG. 11, the second key token 1204 of FIG. 12, and the third key token 1304 of FIG. 13 have been cached using the KV cache 622 of FIG. 6. As a result, the first key token 1104, the second key token 1204, and the third key token 1304 do not need to be recalculated in FIG. 14, but may simply be retrieved from the KV cache 622. Matrix multiplication then may proceed, using fourth key token 1404 as well, and this time with embedding size (emb_size, 4), to obtain resulting products 1401, 1403, 1405, 1406 of size (1, 4). Similarly, the value token 1108, the value token 1208, and the value token 1308 may be cached, so that further matrix multiplication using a fourth value token 1408 and embedding size (4, emb_size) may be executed to obtain attention token 1410 of embedding size (1, emb_size).

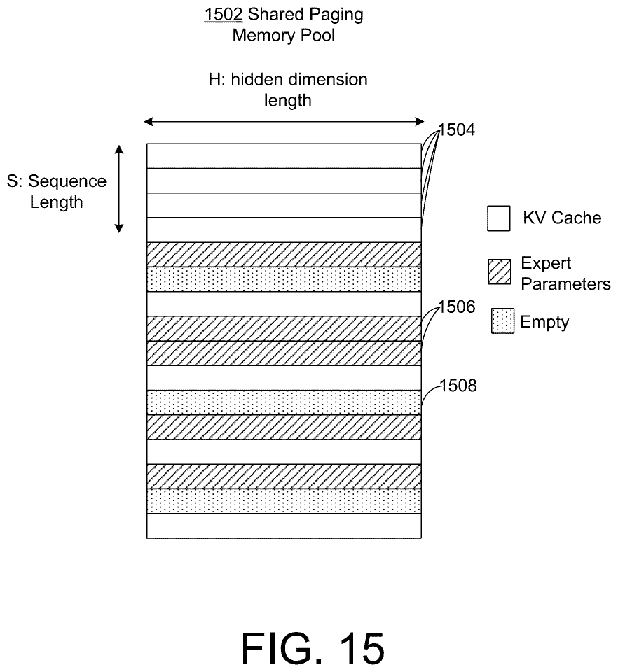

FIG. 15 is a block diagram of an example shared paging memory pool 1502 that can be used in the example system of FIG. 6, including use of the key-value caching approach of FIGS. 11-14. In general, a size of the KV cache may be dependent on a hidden dimension length H and a sequence length S, where the hidden dimension H may refer to a feature vector size that is fixed for purposes of KV caching, while the sequence length S may vary, potentially unpredictably, based on a number of factors, such as desired model output and various hyperparameters.

Due to the variable nature of the sequence length S, in conventional KV cache approaches, it may be difficult to assign contiguous memory locations, resulting in undesirable levels of fragmentation and over-reservation. Shared memory paging may be implemented in a manner similar to virtual memory and paging in the context of conventional operating systems, so that, e.g., continuous keys may be stored in noncontiguous spaces.

In the example of FIG. 15, and as illustrated in FIG. 6, such shared memory for a KV cache may be further shared with multiple expert models and associated parameters (e.g., weights and hyperparameters). For example, FIG. 15 illustrates that rows 1504 of sequence length S may be used for KV cache storage such as described with respect to FIGS. 11-14. Rows 1506 may be used for expert parameters, such as weights or hyperparameters (e.g., rank)., while other rows, such as a row 1508, may be left empty. Through the use of such shared memory, expert models may be swapped easily and efficiently and needed data may be stored in an inter-leaving or noncontiguous manner, with low fragmentation.

As described above with respect to FIGS. 1A-15, ensuring the stability and dependability of extensive networks is a crucial aspect of IT management. Yet, accomplishing this within the practical IT landscape poses significant challenges, given the constantly evolving and widely dispersed nature of large-scale enterprise networks. Effectively managing such environments demands a comprehensive understanding across multiple domains to identify and communicate issues effectively. In example implementations, LLMs may be leveraged for thorough analysis, elucidation, and resolution of IT issues becomes imperative for maintaining high system availability.

Conventional LLMs may rely solely on textual data from events for inference, which restricts an ability to grasp a complete context, where such context may span across various devices and domain topologies, encompassing logs, metrics, traces, tickets, and incidents. Described techniques provide a multi-expert system equipped with task- and tenant-specific adapters, which can be continuously and incrementally trained. This approach facilitates optimal reasoning for determining root causes, assessing impacts, providing explanations, and implementing remedies sourced from diverse domains in real-time. Adopting such a strategy enables IT teams to concentrate their efforts on comprehensively resolving underlying issues by harnessing data from multiple domains, rather than merely addressing surface-level symptoms. Consequently, this leads to more efficient and effective problem resolution.

Described techniques provide an ability to train, manage, and serve numerous independent experts across different domains simultaneously. This is achieved, e.g., by an incremental training framework that can load numerous independent expert adapters or other models into main memory and fetch the adapters used by the currently running queries to the GPU memory to manage numerous expert adapters. Each of these expert adapters utilizes data distributed across several devices over multiple domain topologies, including logs, metrics, traces, tickets, and incidents, as well as situation event graphs. This is accomplished, for example, through adaptively training a multi-expert GPT model using topological, textual, log metric, incidents, and ticket data by incrementally combining multiple historical expert adapter models into a single multitask model without performing additional training.

Additionally, multiple experts may be managed and trained in a scalable way using custom quantization strategies through various tenant data sources across varied domains and services. In particular, described techniques capture context from data distributed across several devices over multiple domain topologies, including logs, metrics, traces, tickets, incidents, and situation event graphs. Such processes follow training multiple expert adapters using a custom LLM Algorithm, which may be based on a Generative Pretrained Transformer. This model comprehends context not only from textual data but also from surrounding events, topology, logs, metrics, tickets, incidents, traces, and the temporal context of IT problems. It may generate a human-readable runbook that not only summarizes the root cause and symptoms but also includes topological characteristics, remediation steps, and comprehensive problem analysis.

The dynamic training of experts is enabled via shared paging, employing a common memory reservoir to handle fluctuating adapter weights with diverse rankings and KV cache tensors (inputs) showcasing varying sequence extents. The historical expert adapters may be combined by judiciously resetting parameters displaying negligible alterations during fine-tuning, reconciling sign discrepancies, and integrating parameters aligning with the ultimately established sign standards. This all-encompassing strategy guarantees streamlined and efficient oversight, instruction, and deployment of numerous expert models comprising multiple expert adapters across a broad spectrum of domains in a scalable and adaptable fashion.

Implementations of the various techniques described herein may be implemented in digital electronic circuitry or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers, including mainframes and distributed servers, at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may, or be operatively coupled to, receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
analyze network data using a combination of a primary model and a secondary model to obtain first network analysis results;
train a training instance of the secondary model using the network data and the first network analysis results;
update the secondary model using the training instance to obtain an updated secondary model; and
process additional network data using a combination of the primary model and the updated secondary model.

2. The computer program product of claim 1, wherein the secondary model includes secondary model weights, the instructions are further configured to cause the at least one computing device to:
train the training instance of the secondary model using the network data and the first network analysis results to thereby obtain training instance weights;
update the secondary model weights using the training instance weights to obtain the updated secondary model having updated secondary model weights; and
process the additional network data using the primary model and the updated secondary model with the secondary model weights.

3. The computer program product of claim 2, wherein the instructions are further configured to cause the at least one computing device to:
determine a magnitude and direction of change of each of the training instance weights, relative to corresponding weights of the secondary model weights; and
retain a subset of the training instance weights for use in updating corresponding secondary model weights to obtain the updated secondary model weights, based on the magnitude and direction of included training instance weights within the subset.

4. The computer program product of claim 2, wherein the instructions are further configured to cause the at least one computing device to:
determine a magnitude and direction of change of a training instance weight of the training instance weights, relative to a corresponding weight of the secondary model weights; and
update the secondary model weights based on the magnitude and direction of change of the training instance weight.

5. The computer program product of claim 1, wherein the instructions are further configured to cause the at least one computing device to:
train a second training instance of the secondary model; and
update the secondary model using the training instance and the second training instance to obtain the updated secondary model.

6. The computer program product of claim 1, wherein the secondary model includes a first secondary model, and further including a second secondary model, and wherein the instructions are further configured to cause the at least one computing device to:
store primary weights of the primary model, first secondary weights of the first secondary model, and second secondary weights of the second secondary model using a graphical processing unit (GPU) memory.

7. The computer program product of claim 6, wherein the instructions are further configured to cause the at least one computing device to:
store the primary weights, the first secondary weights, and the second secondary weights in a shared memory pool of the GPU memory with a cache used to cache values calculated during processing of the network data and the additional network data.

8. The computer program product of claim 7, wherein the cache includes a key-value cache.

9. The computer program product of claim 6, wherein the network data and the additional network data are of a first type, and wherein the instructions are further configured to cause the at least one computing device to:
receive a request for processing received network data of a second type;
determine that the second secondary model is associated with the second type; and
process the received network data using a combination of the primary model and the second secondary model.

10. The computer program product of claim 1, wherein the instructions are further configured to cause the at least one computing device to:
implement the primary model as a large language model (LLM).

11. A computer-implemented method, the method comprising:
analyze network data using a combination of a primary model and a secondary model to obtain first network analysis results;
train a training instance of the secondary model using the network data and the first network analysis results;
update the secondary model using the training instance to obtain an updated secondary model; and
process additional network data using a combination of the primary model and the updated secondary model.

12. The method of claim 11, wherein the secondary model includes secondary model weights, and further comprising:
train the training instance of the secondary model using the network data and the first network analysis results to thereby obtain training instance weights;
update the secondary model weights using the training instance weights to obtain the updated secondary model having updated secondary model weights; and
process the additional network data using the primary model and the updated secondary model with the secondary model weights.

13. The method of claim 12, further comprising:
determine a magnitude and direction of change of each of the training instance weights, relative to corresponding weights of the secondary model weights; and
retain a subset of the training instance weights for use in updating corresponding secondary model weights to obtain the updated secondary model weights, based on the magnitude and direction of included training instance weights within the subset.

14. The method of claim 12, further comprising:
determine a magnitude and direction of change of a training instance weight of the training instance weights, relative to a corresponding weight of the secondary model weights; and
update the secondary model weights based on the magnitude and direction of change of the training instance weight.

15. The method of claim 11, further comprising:
train a second training instance of the secondary model; and
update the secondary model using the training instance and the second training instance to obtain the updated secondary model.

16. The method of claim 11, further comprising:
receive a request for processing received network data of a second type;
determine that a second secondary model is associated with the second type; and
process the received network data using a combination of the primary model and the second secondary model.

17. A system comprising:
at least one memory including instructions; and
at least one processor that is operably coupled to the at least one memory and that is arranged and configured to execute instructions that, when executed, cause the at least one processor to:
analyze network data using a combination of a primary model and a secondary model to obtain first network analysis results;
train a training instance of the secondary model using the network data and the first network analysis results;
update the secondary model using the training instance to obtain an updated secondary model; and
process additional network data using a combination of the primary model and the updated secondary model.

18. The system of claim 17, wherein the secondary model includes secondary model weights, and wherein the instructions are further configured to cause the at least one processor to:
train the training instance of the secondary model using the network data and the first network analysis results to thereby obtain training instance weights;
update the secondary model weights using the training instance weights to obtain the updated secondary model having updated secondary model weights; and
process the additional network data using the primary model and the updated secondary model with the secondary model weights.

19. The system of claim 18, wherein the instructions are further configured to cause the at least one processor to:
determine a magnitude and direction of change of each of the training instance weights, relative to corresponding weights of the secondary model weights; and
retain a subset of the training instance weights for use in updating corresponding secondary model weights to obtain the updated secondary model weights, based on the magnitude and direction of included training instance weights within the subset.

20. The system of claim 18, wherein the instructions are further configured to cause the at least one processor to:
determine a magnitude and direction of change of a training instance weight of the training instance weights, relative to a corresponding weight of the secondary model weights; and
update the secondary model weights based on the magnitude and direction of change of the training instance weight.
